(19) United States
(12) Patent Application Publication
(10) Pub. No.: US 2014/0376219 A1
(43) Pub. Date: Dec. 25, 2014

(54) LIGHT-EMITTING DEVICE, ILLUMINATING APPARATUS, AND DISPLAY APPARATUS

(71) Applicants: Yasuhiro Ono, Osaka-shi (JP); Makoto Masuda, Osaka-shi (JP); Takasumi Wada, Osaka-shi (JP); Kenzo Ohkubo, Osaka-shi (JP); Nobuhiro Shirai, Osaka-shi (JP)

(72) Inventors: Yasuhiro Ono, Osaka-shi (JP); Makoto Masuda, Osaka-shi (JP); Takasumi Wada, Osaka-shi (JP); Kenzo Ohkubo, Osaka-shi (JP); Nobuhiro Shirai, Osaka-shi (JP)

(73) Assignee: SHARP KABUSHIKI KAISHA, Osaka-shi, Osaka (JP)

(21) Appl. No.: 14/006,873

(22) PCT Filed: Feb. 27, 2012
(86) PCT No.: PCT/JP2012/054792

§ 371 Date: Nov. 26, 2013

(30) Foreign Application Priority Data
Mar. 25, 2011 (JP) 2011-066838
Dec. 20, 2011 (JP) 2011-278581

(51) Int. Cl. F21V 7/00; F21V 5/00

(52) U.S. Cl. CPC F21V 7/0025; F21V 5/00
USPC 362/235; 362/308

(57) ABSTRACT

The invention provides a light-emitting device which is capable of applying light to a display panel with uniformity in brightness and can be made lower in profile. A light-emitting device (11) includes an LED chip (111a), a base support (111b) which supports the LED chip (111a), and a lens (112) disposed in contact with the LED chip (111a) so as to cover the LED chip (111a) and the base support (111b). The lens (112) has first curved sections (1122) which reflect light that has reached a top surface (112a) so that the reflected light is emitted from a side surface (112b), and second curved sections (1123) which refract light that has reached the top surface (112a) to outside so that the refracted light is emitted from the top surface (112a).

### TECHNICAL FIELD

The present invention relates to a light-emitting device which is disposed in a backlight unit for applying light to a display panel from a back side, and an illuminating apparatus and a display apparatus including the light-emitting device.

### BACKGROUND ART

In a display panel in which a liquid crystal is sealed in between two transparent substrates, upon application of voltage, the orientations of liquid crystal molecules are changed with consequent variations in light transmittance, so that a predetermined image or the like is displayed in an optical manner. In the display panel, since the liquid crystal does not emit light by itself as a light emitter, for example, a transmissive liquid crystal panel has, at its back side, a backlight unit for effecting irradiation of light from a light source such as a cold-cathode tube (CCFL) or a light-emitting diode (LED).

Backlight units are classified into two categories, namely a direct-lighting type in which light sources such as cold-cathode tubes or LEDs are arranged at the bottom for light emission, and an edge-lighting type in which light sources such as cold-cathode tubes or LEDs are arranged at an edge portion of a transparent plate called a light guide plate, so that light is directed forward, through printed dots or patterns formed at the back, from the edge of the light guide plate.

Although the LED has excellent characteristics, including lower power consumption, longer service life, and the capability of reduction in environmental burdens without the use of mercury, its use as a light source for a backlight unit has fallen behind because of its expensiveness, the fact that there had been no white-color LED prior to the invention of a blue-color LED, and its high directivity. However, in recent years, as white-color LEDs exhibiting high color rendition and high brightness spring into wide use for illumination application purposes, LEDs are becoming less expensive, and consequently, as a light source for a backlight unit, the shift from the cold-cathode tube to the LED has picked up momentum.

LEDs have high directivity, wherefore a backlight unit of edge-lighting type has the advantage over a backlight unit of direct-lighting type from the standpoint of effecting light irradiation in a manner such that a display panel exhibits uniform surface brightness in a planar direction thereof. However, the edge-lighting type backlight unit poses the following problems: localized arrangement of light sources at the edge portion of the light guide plate results in concentration of heat generated by the light sources; and the size of the bezel portion of the display panel is inevitably increased. Furthermore, the edge-lighting type backlight unit is subjected to severe restrictions in terms of local dimming control which attracts attention as a control technique capable of display of high-quality images and energy saving, and is therefore incapable of split-region control that achieves production of high-quality displayed images and low power consumption as well.

In view of the foregoing, studies are going on to come up with a method whereby, even if a highly-directive LED is used as a light source in a direct-lighting type backlight unit having an advantage in its suitability for local dimming control, a display panel can be irradiated with light with evenness in light intensity in the planar direction for uniformity in brightness.

For example, in Patent Literature 1, there is disclosed an inverted cone-shaped light-emitting lamp composed of a light-emitting element, a resin lens having an inverted cone-shaped recess disposed so as to cover the light-emitting element, and a reflective plate disposed to be inclined around the resin lens. Moreover, in Patent Literature 2, there is disclosed a light-emitting diode composed of a light-emitting element and a light-transmittable material disposed so as to cover the light-emitting element, for allowing incident light to diffuse in a lateral direction. Moreover, in Patent Literature 3, there is disclosed a side-lighting-type LED package composed of a light-emitting element and a transparent resin-made molding portion having a centrally-recessed, conically-curved surface disposed so as to cover the light-emitting element. Furthermore, in Patent Literature 4, there is disclosed a light-source unit composed of a light-emitting element, a light guide reflector for guiding light emitted from the light-emitting element while reflecting the light in a direction orthogonal to an optical axis, and a reflective member which surrounds the light-emitting element and extends perpendicularly with respect to an illumination object. In addition, in Patent Literature 5, there is disclosed an illuminating apparatus composed of a light-emitting element and a substantially arc-like reflective plate which surrounds the light-emitting element.

### CITATION LIST

### Patent Literature

Patent Literature 1: Japanese Unexamined Patent Publication JP-A 61-127186 (1986)
Patent Literature 2: Japanese Unexamined Patent Publication JP-A 2003-158302
Patent Literature 3: Japanese Unexamined Patent Publication JP-A 2006-339650
Patent Literature 4: Japanese Unexamined Patent Publication JP-A 2010-238420
Patent Literature 5: U.S. Pat. No. 7,172,325 B2

### SUMMARY OF INVENTION

### Technical Problem

According to the technologies as disclosed in Patent Literatures 1 to 5, light having high directional property emitted from a light-emitting element is diffused in a direction intersected by the optical axis of the light-emitting element, so that a display panel can be irradiated with the light in its planar direction.

In keeping with the recent increasing demand for a display apparatus of even lower profile, a light-emitting device of direct-lighting type that is to be mounted in such a slimmed-down display apparatus is required to have the capability of allowing light emitted from a light-emitting element to diffuse in a direction intersected by the optical axis of the light-emitting element with high accuracy. However, the technologies as disclosed in Patent Literatures 1 to 5 cannot fully satisfy the above requirement.

For example, in the device disclosed in Patent Literature 1, light emitted from the light-emitting element is applied to the inclined reflective plate by the resin lens, and is then reflected from the reflective plate so as to travel toward an illumination object. Therefore, in this device, reflection of light does not occur in a region between the reflective plate and the resin lens, in consequence whereof there results reduction in the quantity of light applied to a part of the illumination object which faces that region.

Moreover, for example, the device disclosed in Patent Literature 2 is a LED light including a light-emitting diode, and, as shown in FIG. 2 of Patent Literature 2, the light-emitting region thereof is given a circular shape, which leads to unsuitability for local dimming.

Moreover, for example, the device disclosed in Patent Literature 3 comprises the side-lighting-type LED package, wherefore light is hardly applied to a part of an illumination object which faces the light-emitting element, in consequence whereof there results reduction in the quantity of light applied to this part.

Furthermore, for example, in the device disclosed in Patent Literature 4, since the reflective member extends perpendicularly with respect to the illumination object, it follows that light emitted horizontally from the light-emitting element is reflected from the reflective member so as to return to the light-emitting element, wherefore the quantity of light at the upper part of the reflective member becomes small, which gives rise to lack of uniformity in irradiated light in the planar direction of the illumination object.

In addition, for example, in the device disclosed in Patent Literature 5, the reflective plate is given a substantially arc-like shape to apply light emitted from the light-emitting element uniformly to an illumination object, and also the angle of incidence of light emitted from the light-emitting element is adjusted. Therefore, if the reflective plate has a small thickness dimension, adjustment to the angle of incidence will become difficult, and consequently the size of the device disclosed in Patent literature 5 will be increased, which makes it difficult to achieve both a downsizing of the device and attainment of uniformity in the quantity of irradiated light.

Accordingly, an object of the invention is to provide a light-emitting device for use in a backlight unit of a display apparatus including a display panel, which is capable of applying light to an illumination object with uniformity in brightness in the planar direction of the illumination object and can be made lower in profile, as well as to provide an illuminating apparatus and a display apparatus including the light-emitting device.

### Solution to Problem

The invention provides a light-emitting device for applying light to an illumination object, comprising:

a light-emitting element that emits light;

a base support that supports the light-emitting element; and

a columnar optical member disposed on a light-emitting surface side of the light-emitting element, reflecting or refracting light emitted from the light-emitting element in a plurality of directions, the columnar optical member having a top surface which faces the illumination object and is shaped so as to have a recess at a center thereof,

the top surface of the columnar optical member including a first region which reflects light emitted from the light-emitting element and travels in an interior of the columnar optical member so that the light exits from a side surface of the columnar optical member to outside of the columnar optical member, and a second region which refracts light emitted from the light-emitting element and travels in the interior of the columnar optical member so that the light exits from the top surface.

Moreover, in the light-emitting device of the invention, it is preferable that the first region lies closer to the light-emitting element than the second region.

Moreover, in the light-emitting device of the invention, it is preferable that the light-emitting device further comprises a light quantity attenuation portion disposed in a recess at the center of the top surface of the columnar optical member, the light quantity attenuation portion diminishing a quantity of incident light.

Moreover, in the light-emitting device of the invention, it is preferable that the light-emitting device further comprises a light quantity adjustment member disposed on an optical axis of the light-emitting element in a region between the columnar optical member and the illumination object to be fixed to the top surface of the columnar optical member, the light quantity adjustment member adjusting light from the columnar optical member.

Moreover, in the light-emitting device of the invention, it is preferable that the light quantity adjustment member is configured so as to extend up to a position beyond a boundary between the first region and the second region of the top surface of the columnar optical member in a direction toward the second region.

Moreover, in the light-emitting device of the invention, it is preferable that the columnar optical member has a reflection portion for reflecting light at a bottom thereof.

Moreover, in the invention, it is preferable that the light-emitting device further comprises a reflective member that reflects light emitted from the columnar optical member, the reflective member comprising a base portion disposed around the columnar optical member so as to extend in a flat form in a direction perpendicular to an optical axis of the columnar optical member, and
an inclined portion surrounding the columnar optical member to be inclined with respect to the base portion, a surface of the inclined portion facing the columnar optical member extending in a flat form.

The invention provides an illuminating apparatus comprising:

a plurality of the light-emitting devices being arranged in an orderly manner.

Moreover, in the illuminating apparatus of the invention, it is preferable that a plurality of the reflective members provided in the light-emitting devices are integrally formed at inclined portions thereof so that the reflective members are continuous with respective adjacent ones.

The invention provides a display apparatus comprising:

a display panel; and

an illuminating apparatus including the light-emitting device or the above-described illuminating apparatus, the illuminating apparatus applying light to a back side of the display panel.

### Advantageous Effects of Invention

According to the invention, the light-emitting device comprises the light-emitting element that emits light, the base support that supports the light-emitting element, and the columnar optical member disposed on the light-emitting surface side of the light-emitting element so as to cover the light-emitting element in contact therewith, the columnar optical member reflecting or refracting light in a plurality of directions. The optical member has a top surface which faces the illumination object and is shaped so as to have a recess at a center thereof. The top surface of the optical member includes the first region which reflects light emitted from the light-emitting element and travels in the interior of the optical member so that the light exits from the side surface of the optical member to the outside, and the second region which refracts light traveling in the interior so that the light exits from the top surface, wherefore light incident on the optical member can be diffused by the top surface. Moreover, in the light-emitting device of the invention, the optical member is placed in contact with the light-emitting element, wherefore the optical member and the light-emitting element are disposed in a highly accurate alignment with each other. This allows the light-emitting device to reflect and refract light emitted from the light-emitting element with high accuracy by the action of the optical member kept in contact with the light-emitting element, and accordingly, the light-emitting device is, even when used in a low-profile display apparatus, capable of applying light to the illumination object with uniformity in brightness in the planar direction.

It is noted that light is emitted from the light-emitting element in a radial fashion about the optical axis. In view of this radial emission of light from the light-emitting element, for the sake of uniformity in brightness in the planar direction of the illumination object, the optical member is configured to have the first region having a light-reflecting capability and the second region having a light-refracting capability.

Moreover, according to the invention, the first region lies closer to the light-emitting element than the second region. This makes it possible to achieve efficient diffusion of light incident on the optical member.

In general, light from a LED, which is a light-emitting element that emits light, peaks in intensity around the optical axis, and decreases in intensity as it travels outward from the optical axis. Accordingly, in order to apply light to a place located far away from the light-emitting element with high efficiency, it is necessary to effect irradiation with light of even higher intensity, and thus, uniformity in light intensity in the device as a whole is attained by applying near-optical-axis light to a distant place, whereas using low-intensity light away from the optical axis for a place close to the light-emitting element where an extra light intensity is not so required.

In the invention, to ensure that the distant place is irradiated with light around the optical axis of the light-emitting element, the optical member has the first region in the vicinity of the optical axis, and the second region located externally circumferentially of the first region.

Moreover, according to the invention, the light quantity attenuation portion is disposed in the recess located at the center of the top surface of the optical member, the light quantity attenuation portion diminishing the quantity of incident light. By virtue of the light quantity attenuation portion, it is possible to achieve reduction in the quantity of light emitted from the central recess of the top surface of the optical member specifically for a region directly above the light-emitting element where a large quantity of light reaches. Accordingly, the light-emitting device is capable of preventing localized brightness variations in the planar direction of the illumination object.

Moreover, according to the invention, the light-emitting device further includes the light quantity adjustment member. The light quantity adjustment member is disposed on the optical axis of the light-emitting element in a region between the optical member and the illumination object to be fixed to the top surface of the optical member, and adjusts light from the optical member. This allows the light-emitting device to apply light to the illumination object with uniformity in light intensity in the planar direction.

Moreover, according to the invention, the light quantity adjustment member is configured so as to extend up to a position beyond the boundary between the first region and the second region of the top surface of the optical member in a direction toward the second region. This makes it possible to suppress occurrence of a phenomenon in which, in the boundary between the first region and the second region of the top surface of the optical member, the illumination object corresponding to the boundary is irradiated with a ring-like ray of light which is higher in brightness than light on both sides (of the boundary). Moreover, since the high-brightness ring-like ray of light as above described, as well as light from the recess, is diffused by the light quantity adjustment member for application of light to the illumination object opposed to the first region, it is possible to make up for the insufficiency of light resulting from light reflection by the first region.

Moreover, according to the invention, the optical member has the reflection portion for reflecting light at the bottom thereof. This allows light which has reached the bottom of the optical member after traveling through the interior thereof to reflect from the reflection portion, with a consequent reduction in loss of light.

Moreover, according to the invention, the light-emitting device further includes the reflective member that reflects light emitted from the optical member. The reflective member comprises the base portion and the inclined portion. The base portion is disposed around the optical member so as to extend in a flat form in a direction perpendicular to the optical axis of the optical member, and the inclined portion surrounds the optical member to be inclined with respect to the base portion, a surface of the inclined portion facing the optical member extending in a flat form.

In the light-emitting device having such a reflective member, light emitted from the optical member, at least partly, reaches the base portion of the reflective member disposed around the optical member. Part of the light which has reached the base portion is reflected from the flat-shaped base portion so as to be applied to the illumination object. Since the light reflected from the base portion travels diffusely, it is possible to apply a sufficient quantity of light not only to that region of the illumination object which faces the optical member, but also to vicinal regions thereof.

Moreover, the other part of the light which has reached the base portion is reflected from the base portion so as to be directed to the inclined portion, is reflected from the flat-shaped inclined portion, and is thereby applied to the illumination object. Accordingly, in the illumination object, not only the regions facing the optical member and the base portion, but also a vicinal region facing the inclined portion can be irradiated with a sufficient quantity of light. This makes it possible to apply light to the illumination object with uniformity in brightness in the planar direction.

Moreover, according to the invention, the illuminating apparatus can be constructed by providing a plurality of the light-emitting devices and arranging them in an orderly manner.

Moreover, according to the invention, in the illuminating apparatus, since a plurality of the reflective members are integrally molded, it is possible to improve the accuracy of placement positions of the optical members relative to their respective reflective members, and thereby allow the reflective member to reflect light in a manner such that a higher level of uniformity in brightness can be ensured in the illumination object in its planar direction.

Moreover, according to the invention, in the display apparatus, light is applied to the back side of the display panel by the illuminating apparatus including the light-emitting devices, wherefore images of even higher quality can be shown on the display panel.

### BRIEF DESCRIPTION OF DRAWINGS

Other and further objects, features, and advantages of the invention will be more explicit from the following detailed description taken with reference to the drawings wherein:

FIG. 1 is an exploded perspective view showing the structure of a liquid-crystal display apparatus 100 in accordance with a first embodiment of the invention;

FIG. 2 is a sectional view of the liquid-crystal display apparatus 100 taken along the line A-A of FIG. 1;

FIG. 3 is a view showing a state where a plurality of light-emitting devices 11 are arranged in an orderly manner;

FIG. 4 is a view showing the positional relationship between an LED chip 111a supported by a base support 111b and a lens 112;

FIG. 5A is a view showing the base support 111b and the LED chip 111a;

FIG. 5B is a view showing the base support 111b and the LED chip 111a;

FIG. 5C is a view showing the base support 111b and the LED chip 111a;

FIG. 6 is a view showing the LED chip 111a and the base support 111b mounted on a printed circuit board 12;

FIG. 7 is a view for explaining an optical path of light emitted from the LED chip 111a;

FIG. 8A is a view for explaining substantial coincidences of an optical axis of the lens 112 and an optical axis of the LED chip 111a in a case where there is one light-emitting point;

FIG. 8B is a view for explaining substantial coincidences of the optical axis of the lens 112 and the optical axis of the LED chip 111a in a case where there is one light-emitting point;

FIG. 8C is a view for explaining substantial coincidences of the optical axis of the lens 112 and the optical axis of the LED chip 111a in a case where there is one light-emitting point;

FIG. 8D is a view for explaining substantial coincidences of the optical axis of the lens 112 and the optical axis of the LED chip 111a in a case where there is one light-emitting point;

FIG. 9A is a view for explaining substantial coincidences of an optical axis of the lens 112 and an optical axis of the LED chip 111a in a case where there are two light-emitting points;

FIG. 9B is a view for explaining substantial coincidences of the optical axis of the lens 112 and the optical axis of the LED chip 111a in a case where there are two light-emitting points;

FIG. 9C is a view for explaining substantial coincidences of the optical axis of the lens 112 and the optical axis of the LED chip 111a in a case where there are two light-emitting points;

FIG. 9D is a view for explaining substantial coincidences of the optical axis of the lens 112 and the optical axis of the LED chip 111a in a case where there are two light-emitting points;

FIG. 10A is a view for explaining substantial coincidences of an optical axis of the lens 112 and an optical axis of the LED chip 111a in a case where there are three light-emitting points;

FIG. 10B is a view for explaining substantial coincidences of the optical axis of the lens 112 and the optical axis of the LED chip 111a in a case where there are three light-emitting points;

FIG. 10C is a view for explaining substantial coincidences of the optical axis of the lens 112 and the optical axis of the LED chip 111a in a case where there are three light-emitting points;

FIG. 10D is a view for explaining substantial coincidences of the optical axis of the lens 112 and the optical axis of the LED chip 111a in a case where there are three light-emitting points;

FIG. 11A is a view for explaining substantial coincidences of an optical axis of the lens 112 and an optical axis of the LED chip 111a in a case where there are four light-emitting points;

FIG. 11B is a view for explaining substantial coincidences of the optical axis of the lens 112 and the optical axis of the LED chip 111a in a case where there are four light-emitting points;

FIG. 11C is a view for explaining substantial coincidences of the optical axis of the lens 112 and the optical axis of the LED chip 111a in a case where there are four light-emitting points;

FIG. 11D is a view for explaining substantial coincidences of the optical axis of the lens 112 and the optical axis of the LED chip 111a in a case where there are four light-emitting points;

FIG. 12 is a view showing the structure of an insert molding machine 400;

FIG. 13A is an exploded view of the insert molding machine 400;

FIG. 13B is an exploded view of the insert molding machine 400;

FIG. 14 is an enlarged view showing a main part of the insert molding machine 400;

FIG. 15 is a perspective view of a reflective member 118 and a light-emitting portion 111;

FIG. 16 is a perspective view of the reflective member 118;

FIG. 17 is a view showing the optical path of light emitted from the light-emitting portion 111;

FIG. 18 is a sectional view showing the structure of a liquid-crystal display apparatus 200 in accordance with a second embodiment of the invention;

FIG. 19 is a sectional view showing the structure of a liquid-crystal display apparatus 300 in accordance with a third embodiment of the invention; and

FIG. 20 is an enlarged view showing a main part of the liquid-crystal display apparatus 300.

### DESCRIPTION OF EMBODIMENTS

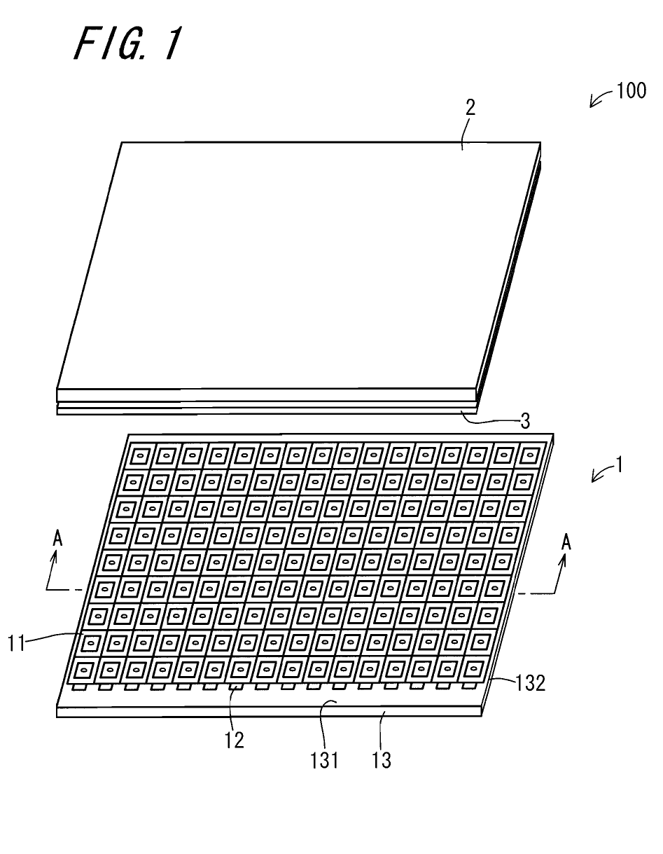

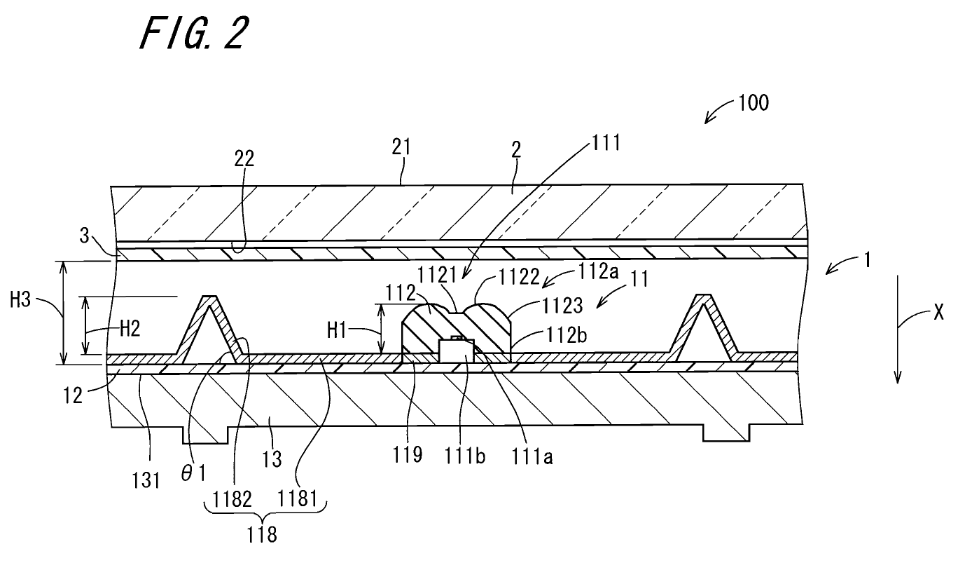

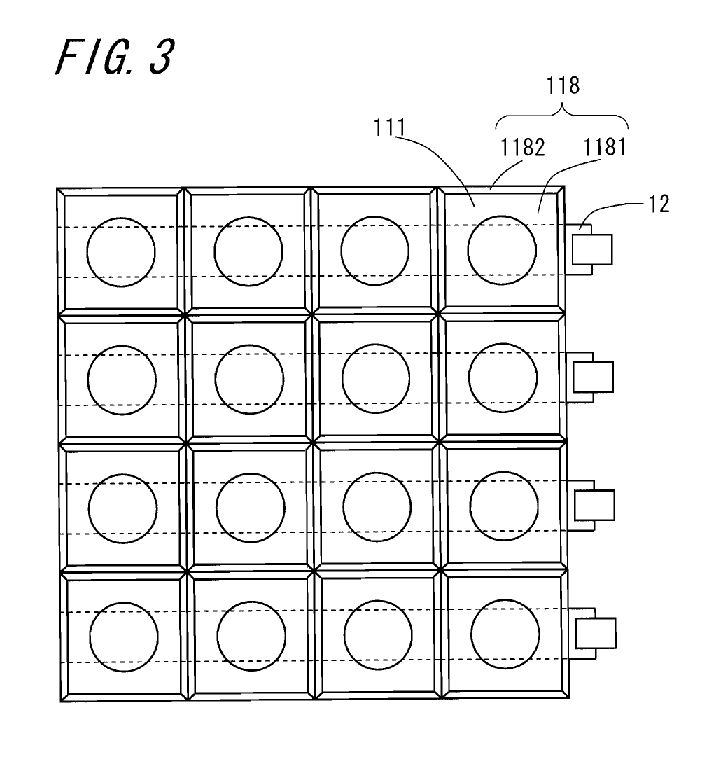

FIG. 1 is an exploded perspective view showing the structure of a liquid-crystal display apparatus 100 in accordance with a first embodiment of the invention. FIG. 2 is a sectional view of the liquid-crystal display apparatus 100 taken along the line A-A of FIG. 1. FIG. 3 is a view showing a state where a plurality of light-emitting devices 11 are arranged in an orderly manner. The liquid-crystal display apparatus 100 which is a display apparatus according to the invention is designed for use in television sets, personal computers, and so forth, for showing an image on a display screen in response to output of image information. The display screen is constructed of a liquid-crystal panel 2 which is a transmissive display panel having liquid-crystal elements, and the liquid-crystal panel 2 has the form of a rectangular flat plate. In the liquid-crystal panel 2, two sides in a thickness-wise direction thereof will be referred to as a front 21 side and a back 22 side, respectively. The liquid-crystal display apparatus 100 shows an image in a manner such that the image is viewable from the front 21 side.

The liquid-crystal display apparatus 100 comprises the liquid-crystal panel 2 and a backlight unit 1 which is an illuminating apparatus including a light-emitting device according to the invention. The liquid-crystal panel 2 is supported on a sidewall portion 132 in parallel relation to a bottom portion 131 of a frame member 13 provided in the backlight unit 1. The liquid-crystal panel 2 includes two substrates, and is shaped like a rectangular plate when viewed in the thickness-wise direction. The liquid-crystal panel 2 includes a switching element such as a TFT (thin film transistor), and a liquid crystal is filled in a gap between the two substrates. The liquid-crystal panel 2 performs display function through irradiation of light from the backlight unit 1 placed at the back 22 side as backlight. The two substrates are provided with a driver (source driver) used for pixel driving control in the liquid-crystal panel 2, and various elements and wiring lines.

Moreover, in the liquid-crystal display apparatus 100, a diffusion plate 3 is disposed between the liquid-crystal panel 2 and the backlight unit 1 in parallel relation to the liquid-crystal panel 2. A prism sheet may be interposed between the liquid-crystal panel 2 and the diffusion plate 3.

The diffusion plate 3 diffuses light emitted from the backlight unit 1 in the planar direction thereof to prevent localized brightness variations. The prism sheet controls the traveling direction of light that has reached there from the back 22 side through the diffusion plate 3 so that the light is directed toward the front 21 side. In the diffusion plate 3, to prevent lack of uniformity in brightness in the planar direction, the traveling direction of light involves, as vector components, many planar-directional components. On the other hand, in the prism sheet, the traveling direction of light involving many planar-directional vector components is converted into a traveling direction of light involving many thickness-directional components. Specifically, the prism sheet is formed by arranging a large number of lenses or prismatic portions in the planar direction, and this arrangement allows reduction in the degree of diffusion of light traveling in the thickness-wise direction. This makes it possible to enhance the brightness of the display in the liquid-crystal display apparatus 100.

The backlight unit 1 is a backlight device of direct-lighting type for applying light to the liquid-crystal panel 2 from the back 22 side. The backlight unit 1 includes a plurality of light-emitting devices 11 for applying light to the liquid-crystal panel 2, a plurality of printed circuit boards 12, and the frame member 13.

The frame member 13 serves as a basic structure of the backlight unit 1, and is composed of the flat plate-shaped bottom portion 131 opposed to the liquid-crystal panel 2, with a predetermined spacing secured between them, and the sidewall portion 132 which is continuous with the bottom portion 131 so as to extend upright therefrom. The bottom portion 131 is rectangular-shaped when viewed in the thickness-wise direction, and its size is slightly larger than the size of the liquid-crystal panel 2. The sidewall portion 132 is formed so as to extend upright toward the front 21 side of the liquid-crystal panel 2 from each of two edges corresponding to the short sides of the bottom portion 131 and another two edges corresponding to the long sides thereof. That is, four flat plate-shaped sidewall portions 132 are formed along the periphery of the bottom portion 131.

The printed circuit board 12 is fixed to the bottom portion 131 of the frame member 13. On the printed circuit board 12 are arranged a plurality of light-emitting devices 11. The printed circuit board 12 is, for example, a glass epoxy-made substrate having an electrically-conductive layer formed on each side.

The plurality of light-emitting devices 11 serve to apply light to the liquid-crystal panel 2. In this embodiment, the plurality of light-emitting devices 11 are arranged in a group, and, a plurality of printed circuit boards 12 each having the plurality of light-emitting devices 11 are juxtaposed so as to face the entire area of the back 22 of the liquid-crystal panel 2, with the diffusion plate 3 lying between them, thereby providing matrix arrangement of the light-emitting devices 11. That is, as shown in FIG. 3 which is an enlarged view of part of FIG. 1, the plurality of light-emitting devices 11 are arranged in an orderly manner. While, in this embodiment, the plurality of light-emitting devices 11 are arranged in a matrix, their arrangement is not so limited. Each of the light-emitting devices 11, which is square-shaped when viewed in a plan view in a direction X perpendicular to the bottom portion 131 of the frame member 13, is designed so that the light quantity level stands at 6000 cd/m² at the liquid-crystal panel 2-sided surface of the diffusion plate 3, and the length of a side of the square shape is set at 55 mm, for example.

Each of the plurality of light-emitting devices 11 comprises a light-emitting portion 111 and a reflective member 118 placed around the light-emitting portion 111 on the printed circuit board 12. The light-emitting portion 111 includes a light-emitting diode (LED) chip 111a which is a light-emitting element, a base support 111b for supporting the LED chip 111a, and a lens 112 which is an optical member.

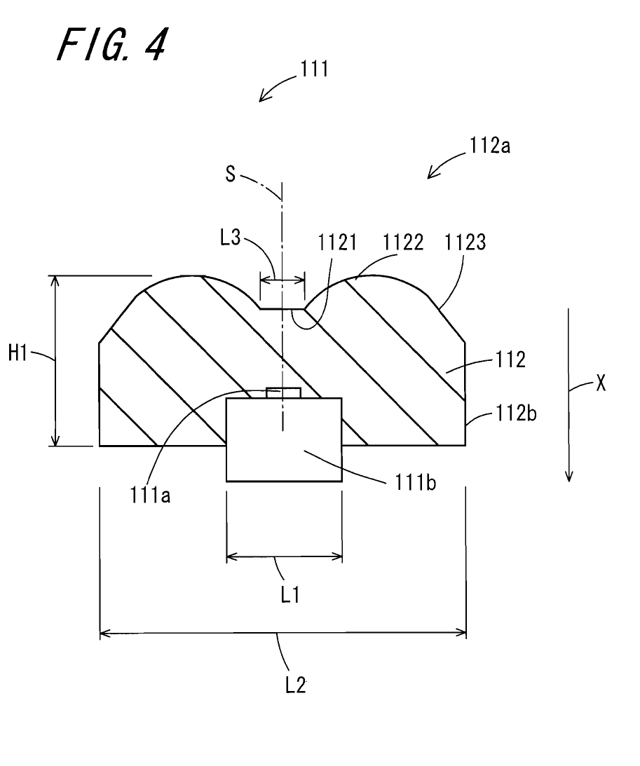

FIG. 4 is a view showing the positional relationship between the LED chip 111a supported by the base support 111b and the lens 112.

The base support 111b is a member for supporting the LED chip 111a. In the base support 111b, its support surface for supporting the LED chip 111a is square-shaped when viewed in a plan view in the direction X, and a length L1 of a side of the square shape is set at 3 mm, for example. Moreover, the height of the base support 111b is set at 1 mm, for example.

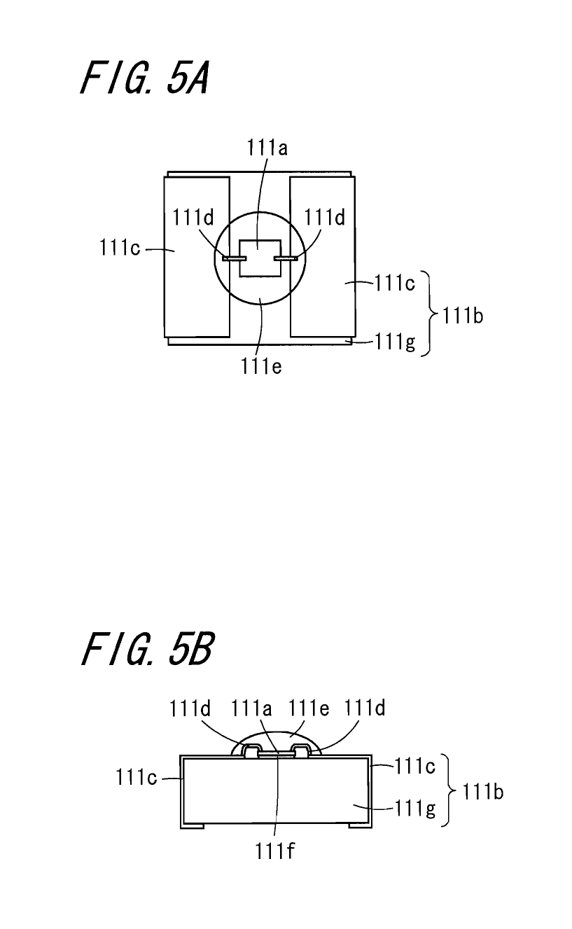

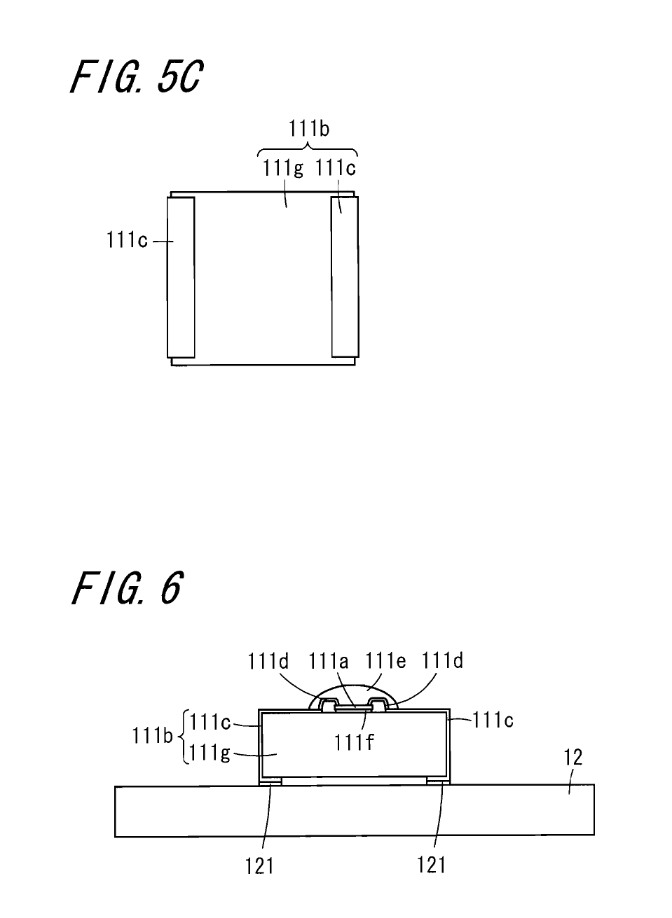

FIGS. 5A to 5C are views showing the base support 111b and the LED chip 111a, of which FIG. 5A is a plan view, FIG. 5B is a front view, and FIG. 5C is a bottom view. As shown in FIGS. 5A to 5C, the base support 111b includes a base main body 111g made of ceramic, resin, or the like, and two electrodes 111c disposed on the base main body 111g, and, the LED chip 111a is secured to a midportion of the top surface of the base main body 111g serving as the support surface of the base support 111b by a bonding member 111f. The two electrodes 111c, which are spaced apart, are each so formed as to extend over the top surface, side surface, and bottom surface of the base main body 111g.

Two terminals (not shown) of the LED chip 111a are connected to their respective two electrodes 111c by two bonding wires 111d. The LED chip 111a and the bonding wire 111d are sealed with a transparent resin 111e such as silicon resin.

FIG. 6 shows the LED chip 111a and the base support 111b mounted on the printed circuit board 12. The LED chip 111a is mounted on the printed circuit board 12, with the base support 111b lying between them, for emitting light in a direction away from the printed circuit board 12. When the light-emitting device 11 is viewed in a plan view in the direction X, the LED chip 111a is located centrally of the base support 111b. In the plurality of light-emitting devices 11, their LED chips 111a can be controlled on an individual basis in respect of light emission. This allows the backlight unit 1 to perform local dimming control.

The LED chip 111a and the base support 111b can be mounted on the printed circuit board 12 by applying solder on each of two connection terminal portions 121 formed in a conductive-layer pattern on the printed circuit board 12, and placing the base support 111b and the LED chip 111a fixed to the base support 111b on the printed circuit board 12 so that the two electrodes 111c formed on the bottom surface of the base main body 111g are brought into registry with their respective solders by an automated machine (not shown), for example. The printed circuit board 12 carrying the base support 111b and the LED chip 111a fixed to the base support 111b is delivered to a reflow bath capable of infrared radiation, and the solder is heated to a temperature of about 260° C., whereby the base support 111b is soldered to the printed circuit board 12.

The lens 112, which is formed on the light-emitting side of the LED chip 111a in contact therewith so as to cover the base support 111b supporting the LED chip 111a by means of insert molding, allows light emitted from the LED chip 111a to undergo reflection or refraction in a plurality of directions. That is, the lens effects light diffusion. The lens 112 is a transparent lens made, for example, of silicon resin or acrylic resin.

The lens 112 is shaped in a substantially cylindrical form, having a top surface 112a which faces the liquid-crystal panel 2 and is curved so as to provide a central recess, and a side surface 112b kept in parallel with an optical axis S of the LED chip 111a, and, a diameter L2 of its section perpendicular to the optical axis S is set at 10 mm, for example. The lens 112 is so formed as to extend outward relative to the base support 111b while making contact with at least part of each side surface of the base support 111b. That is, the lens 112 is larger than the base support 111b with respect to a direction perpendicular to the optical axis S of the LED chip 111a (the diameter L2 of the lens 112 is greater than the length L1 of one side of the support surface of the base support 111b). Thus, where the lens 112 is so formed as to extend outward relative to the base support 111b while making contact with at least part of each side surface of the base support 111b, light emitted from the LED chip 111a can be diffused over an even wider range by the lens 112.

Moreover, a height H1 of the lens 112 is set at 4.5 mm, for example, which is smaller than the diameter L2. In other words, the lens 112 is so configured that the length in a direction perpendicular to the optical axis S of the LED chip 111a (the diameter L2) is greater than the height H1. Light incident on the lens 112 is diffused in a direction intersected by the optical axis S in the interior of the lens 112.

The reason why the diameter L2 is set to be greater than the height H1 as above described is to make the backlight unit 1 lower in profile, as well as to ensure that light is applied evenly to the liquid-crystal panel 2. In order to make the backlight unit 1 lower in profile, the height H1 of the lens 112 needs to be minimized; that is, the lens 112 needs to be thinned as much as possible. However, the reduction in thickness of the lens 112 is likely to cause illuminance variations at the back 22 of the liquid-crystal panel 2, which may result in lack of uniformity in brightness at the front 21 of the liquid-crystal panel 2. Especially in a case where a distance between the adjacent LED chips 111a is long, a region between the LED chips 111a arranged adjacent each other at the back 22 of the liquid-crystal panel 2 is located far away from the LED chip 111a, wherefore the quantity of light applied to that region becomes small, which is likely to cause illuminance (brightness) variations between that region and a region close to the LED chip 111a. In order to ensure that the region located far away from the LED chip 111a is irradiated with light emitted from the LED chip 111a via the lens 112, it is necessary to increase the diameter L2 of the lens 112 to a certain extent, and accordingly, in this embodiment, the slimming-down of the backlight unit 1 and uniform application of light to the liquid-crystal panel 2 can be achieved by setting the diameter L2 to be greater than the height H1 in the lens 112.

If the diameter L2 of the lens 112 is set to be smaller than the height H1 of the lens 112, it will be difficult to achieve the slimming-down of the backlight unit 1 and uniform light application, and in addition, in the process of insert molding for forming the lens 112 in alignment with the LED chip 111a, the lens and the LED chip are likely to get out of balance. Furthermore, when the light-emitting portion 111 composed of the LED chip 111a, the base support 111b, and the lens 112 formed by means of insert molding is soldered to the printed circuit board 12, they are likely to get out of balance, which results in assembly problems.

The top surface of the lens 112 includes a recess portion 1121, a first curved portion 1122, and a second curved portion 1123. In the lens 112, the top surface 112a curved so as to provide a central recess comprises a first region where reaching light is totally reflected for its exit from the side surface 112b and a second region where reaching light is refracted outward for its exit from the top surface 112a. The first region is formed in the first curved portion 1122, and the second region is formed in the second curved portion 1123.

The reason for providing the recess portion 1121, the first curved portion 1122 (first region), and the second curved portion 1123 (second region) at the top surface 112a of the lens 112 will be explained below. Firstly, where the role of the first curved portion 1122 (first region) is concerned, upon reaching the first curved portion 1122, light emitted from the LED chip 111a is totally reflected therefrom for its exit from the side surface 112b. The resultant outgoing light is diffused by the reflective member 118 while radiating far away from the LED chip 111a. This makes it possible to increase the quantity of light in the outward direction (the direction far away from the LED chip 111a). Secondly, where the role of the second curved portion 1123 (second region) is concerned, upon reaching the second curved portion 1122, light emitted from the LED chip 111a is refracted outward so as to radiate toward the diffusion plate 3. The resultant outgoing light is applied to a region to be illuminated in the diffusion plate 3, which is not irradiated sufficiently with light applied from the first curved portion 1122 (first region).

The recess portion 1121 is formed centrally of the top surface 112a opposed to the liquid-crystal panel 2, and the center of the recess portion 1121 (viz., the optical axis of the lens 112) is located on the optical axis S of the LED chip 111a. The bottom surface of the recess portion 1121 is circularly shaped in parallel with the light-emitting surface of the LED chip 111a, and its diameter L3 is set at 1 mm, for example. By way of another embodiment of the invention, instead of having the circularly shaped bottom surface, the recess portion 1121 may by defined by a lateral surface of a cone, the tip of which protrudes toward the LED chip 111a from an imaginary circular base.

The recess portion 1121 is intended to apply light to that region of the diffusion plate 3, which is an illumination object (or the liquid-crystal panel 2), which faces the recess portion 1121. However, since the recess portion 1121 is a part opposed to the LED chip 111a, when most of light emitted from the LED chip 111a reaches the recess portion 1121, and most part of the reaching light passes directly therethrough, then the illuminance of the region facing the recess portion 1121 is significantly increased. With this in view, the shape of the recess portion 1121 should preferably be defined by a lateral surface of a cone as above described. In the case of defining the shape of the recess portion 1121 by the lateral surface of the cone, most of light is reflected from the recess portion 1121, wherefore the quantity of light which passes through the recess portion 1121 is decreased, and consequently the illuminance of the region facing the recess portion 1121 can be regulated.

The first curved portion 1122 is an annular curved surface which merges with the outer edge of the recess portion 1121, and this curved surface gradually extends toward one side of the optical axis S (toward the liquid-crystal panel 2) in a direction from the optical axis S of the LED chip 111a to the outside so as to provide a convexity pointing inwardly toward one side of the optical axis S. As used herein, the term “outer edge” refers to an outermost part of the recess portion with respect to the optical axis S when viewed in a plan view in the direction of the optical axis S, which is defined by the perimeter of a circle about the optical axis S. The curved surface is designed for total reflection of light emitted from the LED chip 111a.

More specifically, out of light emitted from the LED chip 111a, light which has reached the first curved portion 1122 is totally reflected from the first curved portion 1122, is transmitted through the side surface 112b of the lens, and is directed toward a first reflecting portion 1181 of the reflective member 118 as will hereafter be described. Upon reaching the first reflecting portion 1181, the light is diffused by the first reflecting portion 1181, and, part of the diffused light is applied to that region of the diffusion plate 3 acting as the illumination object (or the liquid-crystal panel 2) which is not opposed to the LED chip 111a but opposed to the first reflecting portion 1181. Moreover, another part of the diffused light is directed toward a second reflecting portion 1182 of the reflective member 118 as will hereafter be described, and is diffused by the second reflecting portion 1182, and, the diffused light is applied to that region of the diffusion plate 3 acting as the illumination object (or the liquid-crystal panel 2) which is not opposed to the LED chip 111a but opposed to the second reflecting portion 1182. In this way, the quantity of light applied to the region which is not confronted by the LED chip 111a can be increased.

In the interest of total reflection of light emitted from the LED chip 111a, the first curved portion 1122 is so configured that the angle of incidence of light emitted from the LED chip 111a is greater than or equal to a critical angle φ. For example, given that acrylic resin is used as the material for the lens 112, the refractive index of the acrylic resin is 1.49, whereas the refractive index of air is 1, wherefore the following relationship is obtained: sin φ=1/1.49. A critical angle φ of 42.1° is derived from this relational expression, and correspondingly the first curved portion 1122 is so configured that the incident angle is greater than or equal to 42.1°. On the other hand, for example, given that silicon resin is used as the material for the lens 112, the refractive index of the silicon resin is 1.43, whereas the refractive index of air is 1, wherefore the following relationship is obtained: sin φ=1/1.43. A critical angle φ of 44.4° is derived from this relational expression, and correspondingly the first curved portion 1122 is so configured that the incident angle is greater than or equal to 44.4°.

The second curved portion 1123 is an annular curved surface which merges with the outer edge of the first curved portion 1122, and extends toward the other side of the optical axis S (located away from the liquid-crystal panel 2) in a direction from the optical axis S of the LED chip 111a to the outside so as to provide a convexity pointing outwardly toward one side of the optical axis S.

In this embodiment, the lens 112 has a reflection portion 119 for reflecting light formed over the entire bottom thereof. This allows light which has reached the bottom after traveling through the interior of the lens 112 to reflect from the reflection portion 119, with a consequent reduction in loss of light. The reflection portion 119 can be formed by means of application of a sheet of silver or aluminum, vapor deposition of aluminum, or otherwise. The thickness of the reflection portion 119 is set at 50 μm, for example, and the reflection portion 119 reflects visible light emitted from the LED chip 111a at a reflectivity (total reflectivity) of greater than or equal to 98%. Note that aluminum vapor deposition is effected by heating aluminum in a vessel maintained under vacuum so that it adheres to the bottom of the lens 112 that is a target of the vapor deposition.

Out of light emitted from the LED chip 111a, light which has reached the second curved portion 1123 is refracted in a direction toward the light-emitting portion 111 (direction X) when passing through the second curved portion 1123 so as to travel toward the diffusion plate 3 and the reflective member 118. Upon reaching the reflective member 118, the light is diffused for travel toward the diffusion plate 3. The light thusly directed toward the diffusion plate 3 by the second curved portion 1123 is mainly applied to a region of the diffusion plate 3 that differs from the region irradiated with light from the recess portion 1121 and the first curved portion 1122, which makes up for the insufficiency of light quantity. Note that the second curved portion 1123 is required to allow transmission of light, and is therefore configured so that the incident angle is smaller than 42.1° to avoid total reflection of light emitted from the LED chip 111a.

Thus, in the lens 112, the outer edge of the recess portion 1121 is formed with the first curved portion 1122 capable of totally reflecting light emitted from the LED chip 111a for its travel toward the side surface 112b of the lens 112, and the outer edge of the first curved portion 1122 is formed with the second curved portion 1123 capable of refracting light emitted from the LED chip 111a. In general, the LED chip 111a has high directivity, and the quantity of light in the vicinity of the optical axis S is very large, and thus, the quantity of light decreases as the exit angle of light with respect to the optical axis S is increased. Accordingly, in order to increase the quantity of light applied to a region located relatively far away from the optical axis S of the LED chip 111a (viz., the optical axis of the lens 112), rather than light having a large exit angle with respect to the optical axis S, light having a small exit angle with respect to the optical axis S needs to directed toward that region. In this embodiment, as has already been described, since the first curved portion 1122 capable of totally reflecting light for its travel toward that region is formed in contiguous relation around the recess portion 1121 through which the optical axis S passes, it is possible to increase the quantity of light applied to that region. By contrast, if the second curved portion 1123 is formed around the recess portion 1121 in contiguous relation, and the first curved portion 1122 is formed around the second curved portion 1123 in contiguous relation, light traveling toward the first curved portion 1122 will exhibit a larger exit angle with respect to the optical axis S, with a consequent decrease in the quantity of light applied to that region through total reflection in the first curved portion 1122.

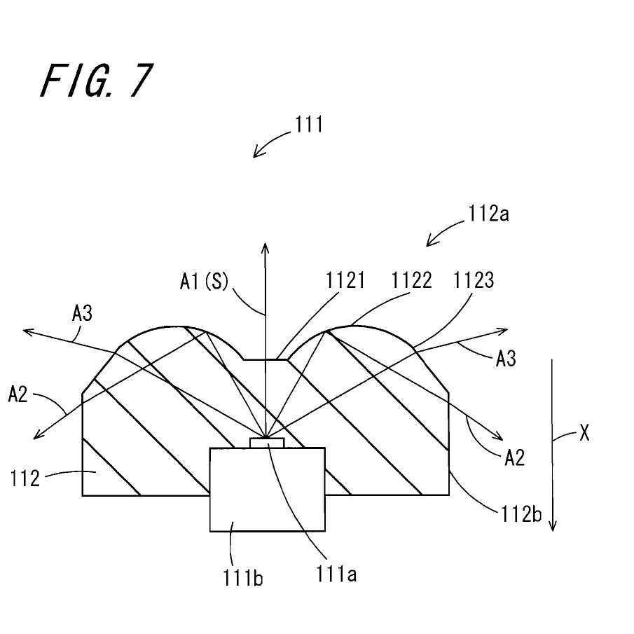

FIG. 7 is a view for explaining the optical path of light emitted from the LED chip 111a. Light emitted from the LED chip 111a enters the lens 112, and is then diffused by the lens 112. Specifically, out of light incident on the lens 112, light which has reached the recess portion 1121 at the top surface 112a opposed to the liquid-crystal panel 2 is caused to exit in a direction indicated by arrow A1 for its travel toward the liquid-crystal panel 2; light which has reached the first curved portion 1122 is reflected therefrom to exit from the side surface 112b for its travel in a direction indicated by arrow A2; and light which has reached the second curved portion 1123 is refracted outward (in a direction away from the LED chip 111a) to exit in a direction indicated by arrow A3 for its travel toward the liquid-crystal panel 2.

Moreover, in this embodiment, the LED chip 111a and the lens 112 are formed in a highly accurate predetermined alignment with each other in a manner such that the center of the lens 112 (viz., the optical axis of the lens 112) is located on the optical axis S of the LED chip 111a, and the lens 112 is brought into contact with the LED chip 111a.

As used herein, the term “the optical axis of the lens 112” refers to an imaginary ray of light which is a representative of a ray bundle passing through the lens 112, and the lens 112 is formed of planes that are rotationally symmetrical about a single axis (optical axis).

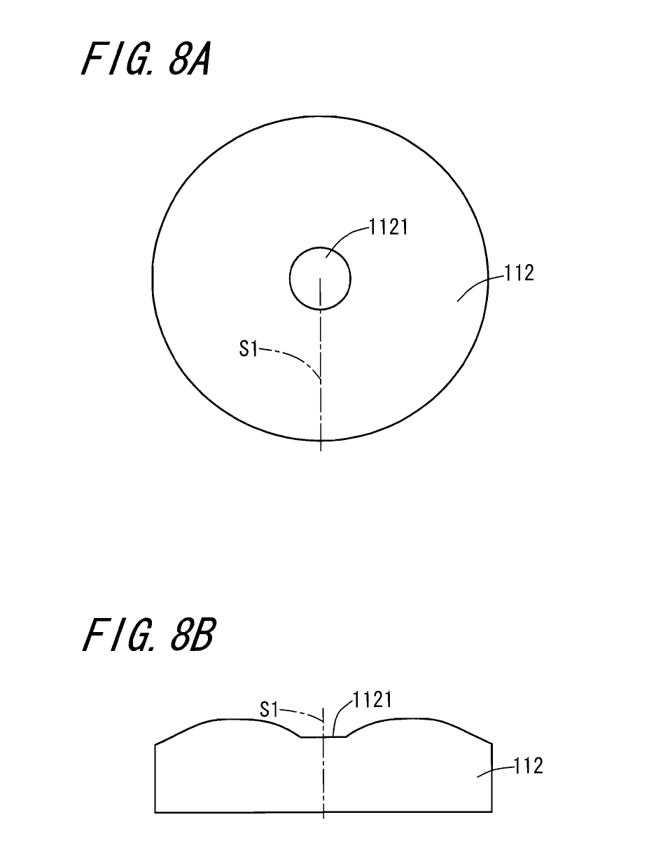

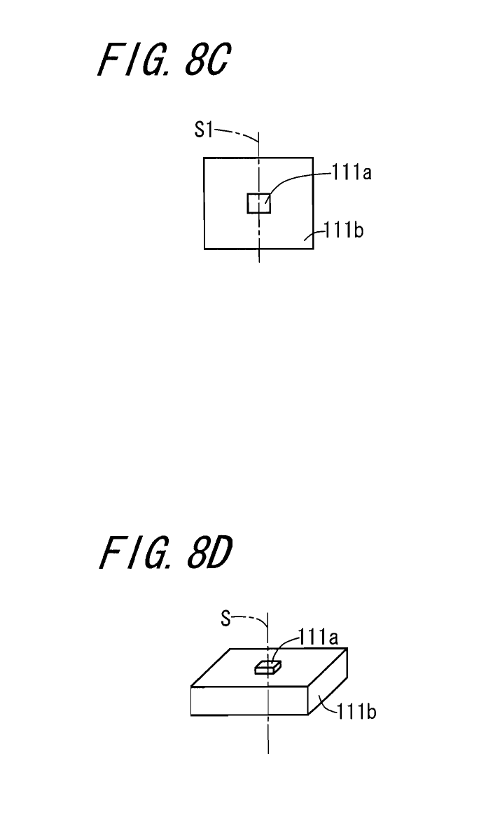

FIGS. 8A to 8D are views for explaining substantial coincidences of the optical axis of the lens 112 and the optical axis of the LED chip 111a in a case where there is one light-emitting point. In FIGS. 8A to 8D, in order to facilitate the understanding of the explanation, the lens 112 and the LED chip 111a supported by the base support 111b are illustrated as being spaced apart. Moreover, in FIGS. 8A to 8D, a single LED chip 111a is supported on the base support 111b, and this case corresponds to the case where there is one light-emitting point. FIG. 8A shows the lens 112 as viewed from above in the direction of the optical axis S1 of the lens 112; FIG. 8B shows a sectional view of the lens 112 as viewed in a direction perpendicular to the optical axis S1; FIG. 8C shows the LED chip 111a supported by the base support 111b as viewed from above in the direction of the optical axis S of the LED chip 111a; and FIG. 8D is a perspective view of the LED chip 111a supported by the base support 111b. The optical axis S1 of the lens 112 is defined by a straight line passing through the center of the lens 112 perpendicularly to the bottom of the recess portion 1121. On the other hand, the optical axis S of the LED chip 111a is defined by a straight line passing through the light-emitting point of the one LED chip 111a perpendicularly to the light-emitting surface. In this embodiment, the optical axis S1 of the lens 112 and the optical axis S of the LED chip 111a thusly prescribed substantially coincide with each other.

In the invention, the term “substantial coincidences of the optical axis S1 of the lens 112 and the optical axis S of the LED chip 111a” means not only that the optical axis S1 and the optical axis S are in exact registration with each other without any misalignment, but also that the optical axis S1 and the optical axis S are assumed to coincide with each other so long as the amount of misalignment between the optical axis S1 and the optical axis S which is a spacing between them in a horizontal direction (hereafter referred to as “the amount of optical-axis misalignment”), falls within a predetermined permissible range.

The permissible range of the amount of optical-axis misalignment is determined, with consideration given to the configuration (thickness, outer diameter, etc.) of the lens 112 and so forth, so that a sufficient level of uniformity in brightness can be ensured at the liquid-crystal panel 2-sided surface of the diffusion plate 3 (unevenness in brightness falls within 8%), and, in this embodiment, the permissible range of the amount of optical-axis misalignment is 70 μm or less. The method of adjusting the amount of optical-axis misalignment to fall within the permissible range of 70 μm or less will be described in detail later.

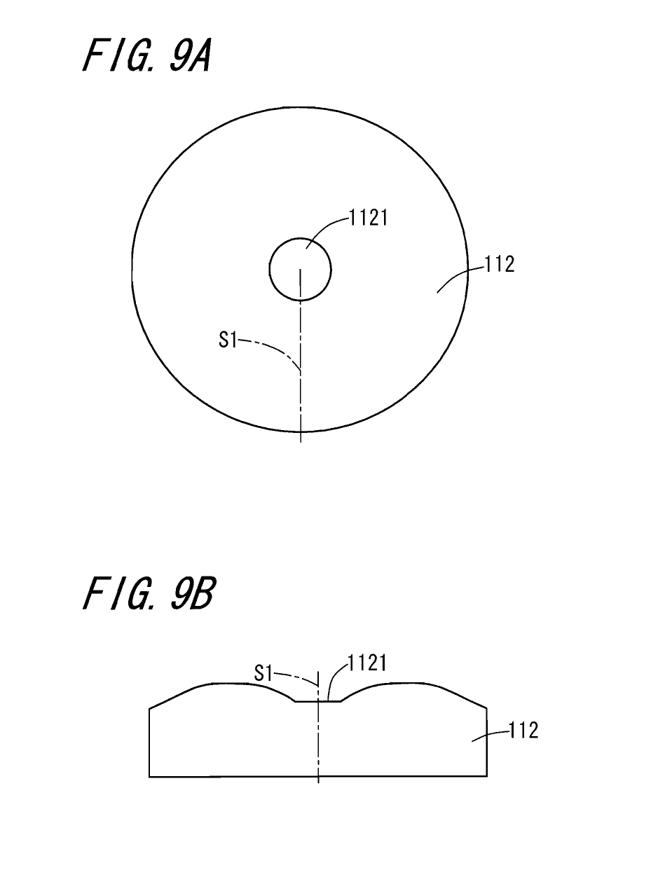

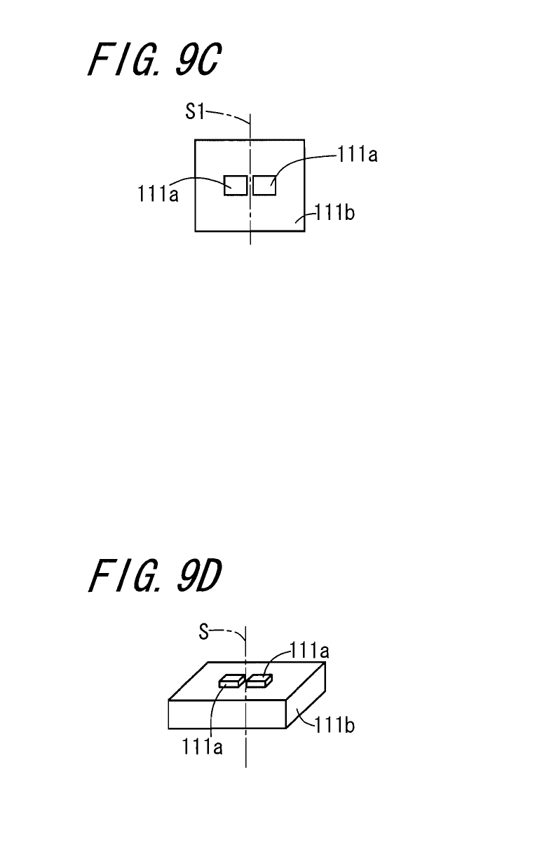

FIGS. 9A to 9D are views for explaining substantial coincidences of the optical axis of the lens 112 and the optical axis of the LED chip 111a in a case where there are two light-emitting points. In FIGS. 9A to 9D, in order to facilitate the understanding of the explanation, the lens 112 and the LED chip 111a supported by the base support 111b are illustrated as being spaced apart. Moreover, in FIGS. 9A to 9D, two LED chips 111a are supported on the base support 111b, and this case corresponds to the case where there are two light-emitting points. FIG. 9A shows the lens 112 as viewed from above in the direction of the optical axis S1 of the lens 112; FIG. 9B shows a sectional view of the lens 112 as viewed in a direction perpendicular to the optical axis S1; FIG. 9C shows the LED chip 111a supported by the base support 111b as viewed from above in the direction of the optical axis S of the LED chip 111a; and FIG. 9D is a perspective view of the LED chip 111a supported by the base support 111b. The optical axis S1 of the lens 112 is defined by a straight line passing through the center of the lens 112 perpendicularly to the bottom of the recess portion 1121. On the other hand, the optical axis S of the LED chip 111a is defined by a straight line passing through the center of a line segment connecting the two light-emitting points of the two LED chips 111a, respectively, so as to be perpendicular to the light-emitting surface. In this embodiment, the optical axis S1 of the lens 112 and the optical axis S of the LED chip 111a thusly prescribed substantially coincide with each other.

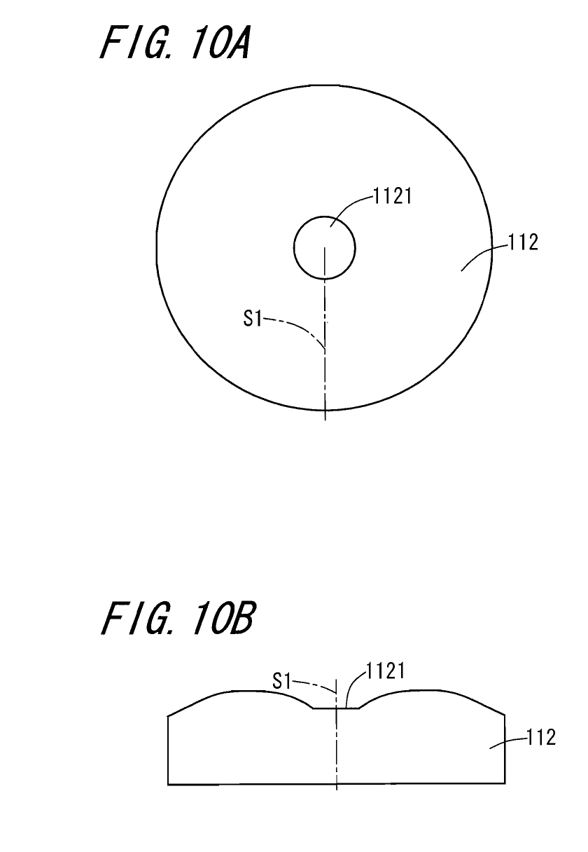

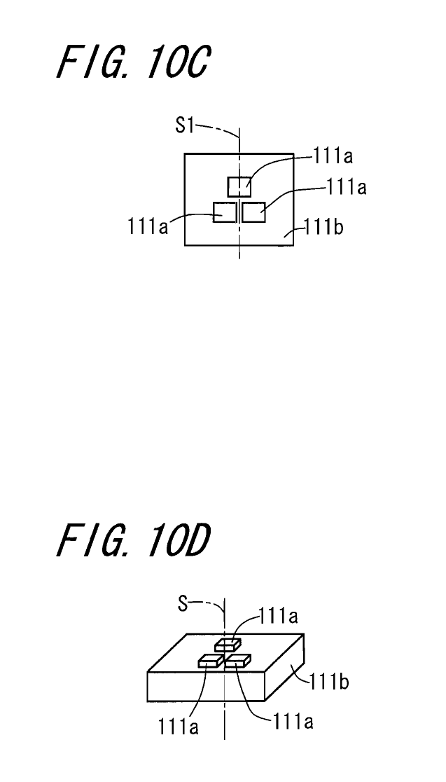

FIGS. 10A to 10D are views for explaining substantial coincidences of the optical axis of the lens 112 and the optical axis of the LED chip 111a in a case where there are three light-emitting points. In FIGS. 10A to 10D, in order to facilitate the understanding of the explanation, the lens 112 and the LED chip 111a supported by the base support 111b are illustrated as being spaced apart. Moreover, in FIGS. 10A to 10D, three LED chips 111a are supported on the base support 111b, and this case corresponds to the case where there are three light-emitting points. FIG. 10A shows the lens 112 as viewed from above in the direction of the optical axis S1 of the lens 112; FIG. 10B shows a sectional view of the lens 112 as viewed in a direction perpendicular to the optical axis S1; FIG. 10C shows the LED chip 111a supported by the base support 111b as viewed from above in the direction of the optical axis S of the LED chip 111a; and FIG. 10D is a perspective view of the LED chip 111a supported by the base support 111b. The optical axis S1 of the lens 112 is defined by a straight line passing through the center of the lens 112 perpendicularly to the bottom of the recess portion 1121. On the other hand, the optical axis S of the LED chip 111a is defined by a straight line passing through the center of a triangle whose vertices define the three light-emitting points of the three LED chips 111a, respectively, so as to be perpendicular to the light-emitting surface. In this embodiment, the optical axis S1 of the lens 112 and the optical axis S of the LED chip 111a thusly prescribed substantially coincide with each other.

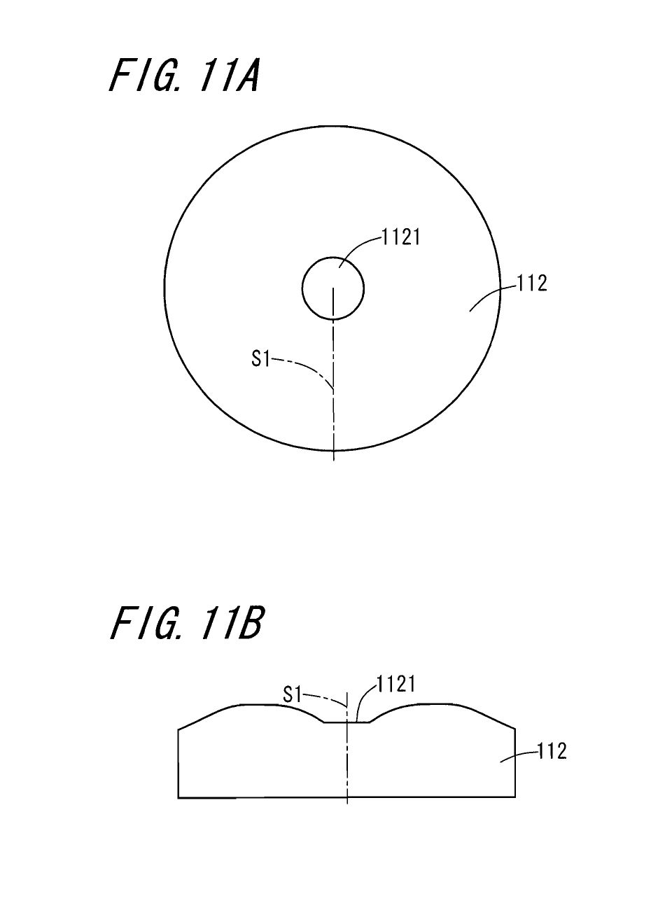

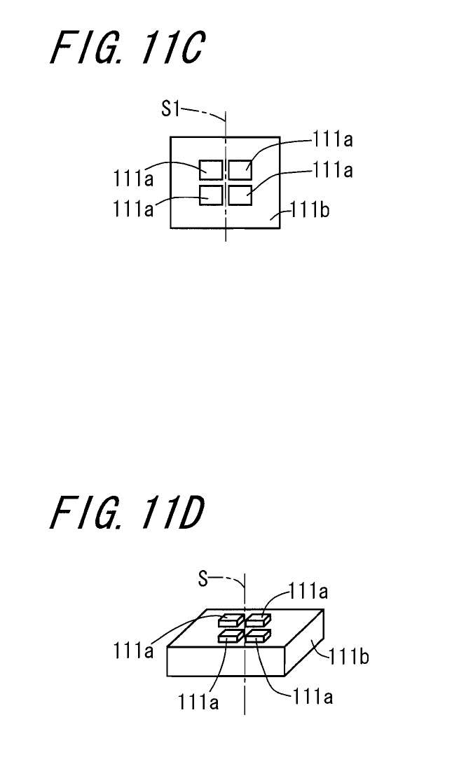

FIGS. 11A to 11D are views for explaining substantial coincidences of the optical axis of the lens 112 and the optical axis of the LED chip 111a in a case where there are four light-emitting points. In FIGS. 11A to 11D, in order to facilitate the understanding of the explanation, the lens 112 and the LED chip 111a supported by the base support 111b are illustrated as being spaced apart. Moreover, in FIGS. 11A to 11D, four LED chips 111a are supported on the base support 111b, and this case corresponds to the case where there are four light-emitting points. FIG. 11A shows the lens 112 as viewed from above in the direction of the optical axis S1 of the lens 112; FIG. 11B shows a sectional view of the lens 112 as viewed in a direction perpendicular to the optical axis S1; FIG. 11C shows the LED chip 111a supported by the base support 111b as viewed from above in the direction of the optical axis S of the LED chip 111a; and FIG. 11D is a perspective view of the LED chip 111a supported by the base support 111b. The optical axis S1 of the lens 112 is defined by a straight line passing through the center of the lens 112 perpendicularly to the bottom of the recess portion 1121. On the other hand, the optical axis S of the LED chip 111a is defined by a straight line passing through the center of a quadrangle whose vertices define the four light-emitting points of the four LED chips 111a, respectively, so as to be perpendicular to the light-emitting surface. In this embodiment, the optical axis S1 of the lens 112 and the optical axis S of the LED chip 111a thusly prescribed substantially coincide with each other.

Examples of the method of forming the LED chip 111a and the lens 112 in a predetermined alignment with each other include insert molding technique and a process of fitting the LED chip 111a supported by the base support 111b to the lens 112 formed in a predetermined shape. In this embodiment, the LED chip 111a and the lens 112 are formed in a predetermined alignment with each other by the insert molding technique.

Molds used for insert molding are broadly classified into an upper mold and a lower mold. Insert molding is effected by pouring, from a resin inlet, a resin used as the raw material of the lens 112 into a space created when the upper mold and the lower mold are put together, while retaining the LED chip 111a. Alternatively, it is also possible to pour a resin used as the raw material of the lens 112 into a space created when the upper mold and the lower mold are put together from a resin inlet, while retaining the LED chip 111a supported by the base support 111b. In this way, where the LED chip 111a and the lens 112 are formed by the insert molding technique, the lens 112 can be brought into highly accurate alignment with the LED chip 111a while making contact therewith. This allows the backlight unit 1 to reflect and refract light emitted from the LED chip 111a with high accuracy by the action of the lens 112 kept in contact with the LED chip 111a, and accordingly, even in the low-profile liquid-crystal display apparatus 100 in which a distance H3 from the diffusion plate 3 to the printed circuit board 12 is short (for example, H3 is set at 6 mm), the backlight unit 1 is capable of applying light to the display panel 2 with uniformity in light intensity in the planar direction.

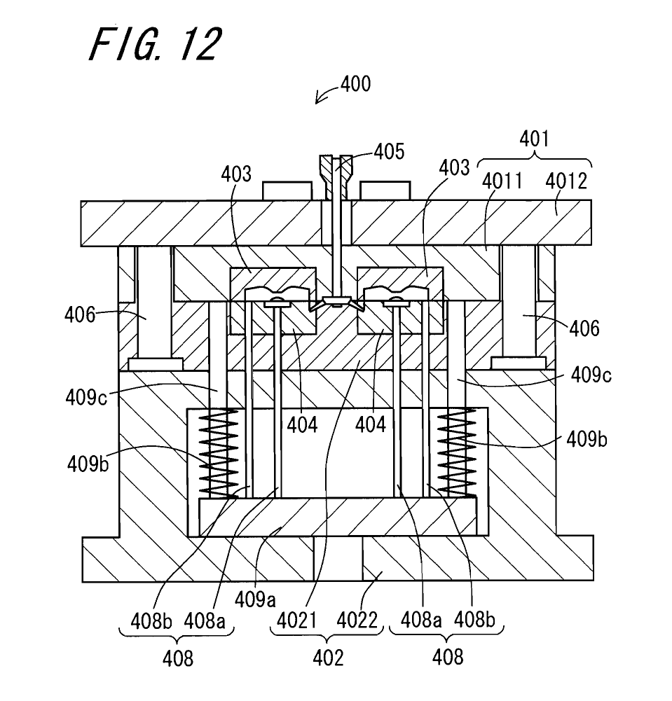

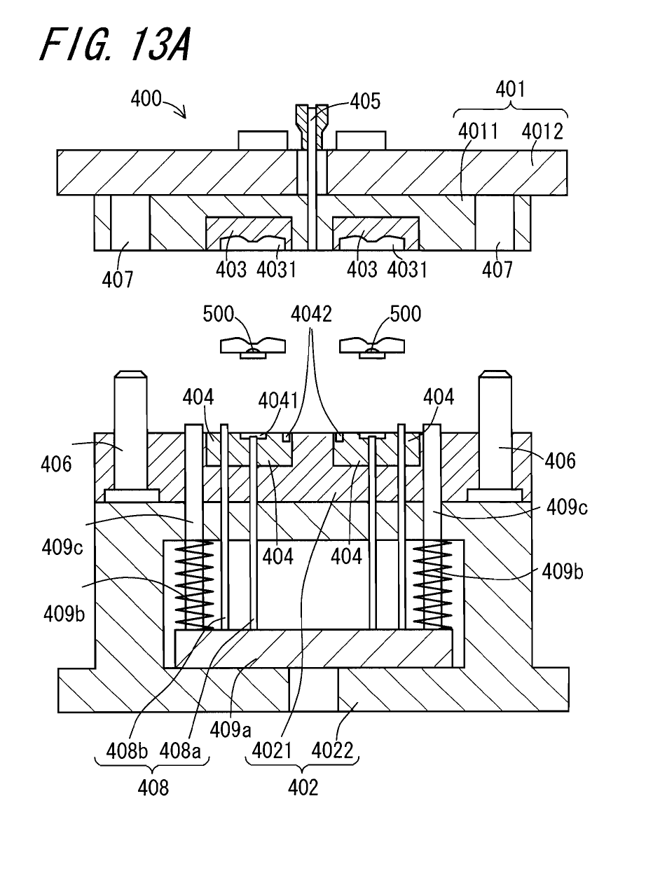

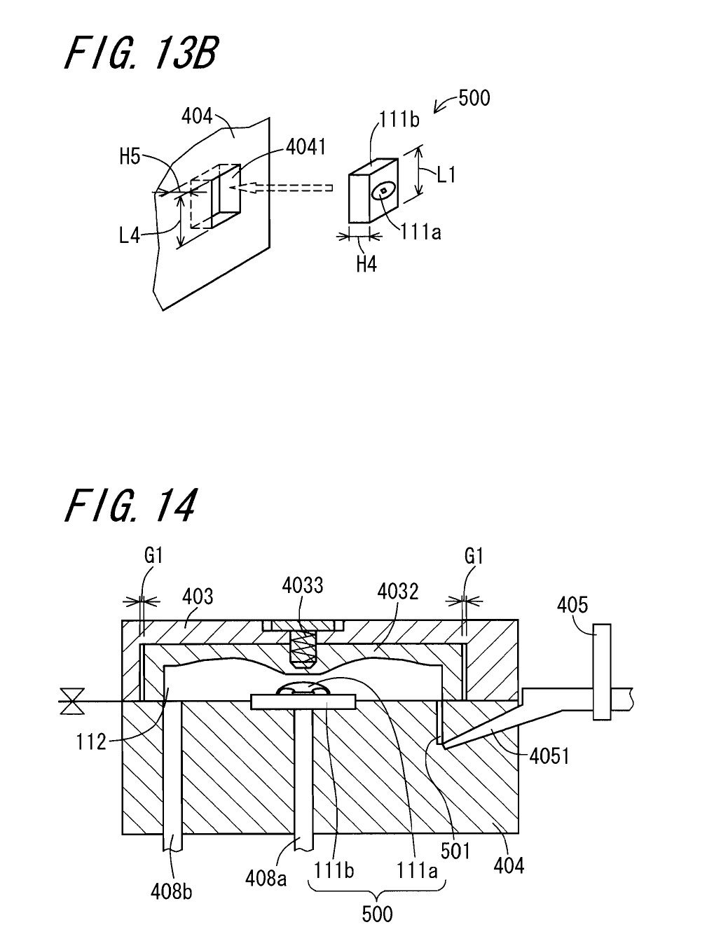

Now, a description will be given below as to the insert molding technique for pouring a resin used as the raw material of the lens 112 from a resin inlet while retaining the LED chip 111a supported by the base support 111b. FIG. 12 is a view showing the structure of an insert molding machine 400. In FIG. 12, there is shown a state where a stationary plate 401 and a movable plate 402 are kept in intimate contact with each other. FIGS. 13A and 13B are exploded views of the insert molding machine 400. FIGS. 13A and 13B show a state where the movable plate 402 is located away from the stationary plate 401 for removal of an insert-molded product. FIG. 14 is an enlarged view showing a main part of the insert molding machine 400.

The insert molding machine 400 is a two-plate injection molding machine composed of the stationary plate 401 including a stationary-side mold plate 4011 mounted on a stationary-side adapter plate 4012 and the movable plate 402 including a movable-side mold plate 4021 mounted on a movable-side adapter plate 4022. The movable plate 402 can be moved toward and away from the stationary plate 401. The insert molding machine 400 is further provided with a sprue runner 405, a guide pin 406, an EJ pin 408, and an ejector plate 409a fitted with a return spring 409b. The ejector plate 409a is fitted with a pin 409c inserted in the return spring 409b.

The stationary-side mold plate 4011 of the stationary plate 401 is fitted with an upper mold 403 having a lens-shaped recess 4031 for creating a space conforming to the shape of the lens 112 which is a molded product. Moreover, the movable-side mold plate 4021 of the movable plate 402 is fitted with a lower mold 404 having a LED-shaped recess 4041 and a resin flow-receiving recess 4042. The LED-shaped recess 4041 is intended to create a quadrangular prism-like space conforming to the shape of the LED chip 111a supported by the base support 111b (hereafter referred to as “LED 500”) which is an inserted component. The resin flow-receiving recess 4042 is intended to create a space conforming to the shape of a locator boss part 501 which is formed at the bottom of the lens 112 during formation of the lens 112 (the locator boss part 501 is an unnecessary part which is cut away following the completion of molding). In the process of insert molding, a molten resin flowing from the sprue runner 405 flows into the lens-shaped recess 4031 through the resin flow-receiving recess 4042.

Moreover, as shown in FIG. 14, a core mold 4032 is disposed between the upper mold 403 and the lower mold 404, and the core mold 4032 is spaced a predetermined distance G1 (0.2 mm) away from the upper mold 403 in the horizontal direction. Adjustment of the position of the core mold 4032 relative to the lower mold 404 is made by using an adjustment bolt 4033 placed above the core mold 4032.

The sprue runner 405 is a member intended to cause a molten resin (resin for constituting the lens 112, for example, silicon resin) ejected from a nozzle (not shown) to flow into the lens-shaped recess 4031, and more specifically cause the molten resin to flow into the lens-shaped recess 4031 through a gate 4051 (of submarine gate type) connected to the resin flow-receiving recess 4042.

The guide pin 406 is a pin fixed to the movable-side adapter plate 4022. When the movable plate 402 is moved to a predetermined position for an approach to the stationary plate 401 to effect insert molding, then the guide pin 406 is inserted into an insertion hole 407 formed in the stationary-side mold plate 4011, whereby the movable plate 402 can be brought into alignment with the stationary plate 401.

The EJ pin 408 is a pin fixed to the ejector plate 409a, which includes a pin for LED 408a and a pin for lens 408b. The pin for LED 408a acts, upon the movement of the movable plate 402 away from the stationary plate 401 following the completion of insert molding, to push the bottom of the base support 111b for the LED 500 inserted in the LED-shaped recess 4041 from below upward in a vertical direction for removal of an insert-molded product from the LED-shaped recess 4041. On the other hand, the pin for lens 408b acts, upon the movement of the movable plate 402 away from the stationary plate 401 following the completion of insert molding, to push the bottom of the lens 112 secured to the LED 500 from below upward in the vertical direction for removal of the insert-molded product from the LED-shaped recess 4041.

Next, the method of forming the insert-molded product comprising the LED 500 and the lens 112 fixed thereto by using the insert molding machine 400 will be described.

As shown in FIG. 13B, the first step is to insert the LED 500 which is an inserted product into the LED-shaped recess 4041 of the lower mold 404. The LED 500 can be inserted into the LED-shaped recess 4041 either by manual operation with operator's hands or by robot arm operation. The size of the LED-shaped recess 4041 is determined, with consideration given to the insertability of the LED 500, on the basis of the size of the base support 111b for the LED 500. Specifically, in the LED-shaped recess 4041, a length L4 of a side of a square defining the opening shape is set at 3.03 mm (3 mm+30 μm), whereas the length L1 of a side of the base support 111b is 3 mm, and, a recess height H5 is set at 0.5 mm, whereas the height H4 of the base support 111b is 1 mm.

Among the base supports 111b, due to production lot differences, variation in the side length L1 occurs within the range of 10 μm. “40 μm”, which is the sum of this range of variation (10 μm) in the side length L1 and clearance for insertion of the LED 500 into the LED-shaped recess 4041 (L4−L1=30 μm), is a value for the range of variation in the insertion of the LED 500 into the LED-shaped recess 4041 in the horizontal direction (a direction perpendicular to the direction X).

Next, the movable plate 402 is moved in a direction toward the stationary plate 401 (moved upward in the vertical direction) for intimate contact between the movable plate 402 and the stationary plate 401. In this way, when the movable plate 402 and the stationary plate 401 make intimate contact with each other, the upper mold 403 and the lower mold 404 can be brought into intimate contact with each other correspondingly, whereby a space created by the lens-shaped recess 4031 of the upper mold 403 becomes an enclosed space.

Among the LED chips 111a, due to production lot differences, variation in the horizontal position of the optical axis S relative to the base support 111b occurs (the range of variation in the position of the optical axis S of the LED chip 111a relative to the base support 111b resulting from production lot differences: 20 μm or less). This variation can be accommodated by making adjustment to the horizontal position of the core mold 4032 relative to the lower mold 404 on a batch-by-batch basis by using the adjustment bolt 4033.

Next, with the movable plate 402 and the stationary plate 401 kept in intimate contact with each other, a molten resin is fed from the gate 4051 of the sprue runner 405 so that it flows into the lens-shaped recess 4031 through the resin flow-receiving recess 4042, thereby forming the lens 112, and the lens 112 is secured to the LED 500 inserted in the LED-shaped recess 4041 opposed to the lens-shaped recess 4031. At this time, the lens 112 is molded under the condition that the permissible range of horizontal displacement of the optical axis S1 resulting from variation in molding requirements and so forth should be 10 μm or less. Note that the bottom of the thusly molded lens 112 is formed with the locator boss part 501 shaped in conformity to the resin flow-receiving recess 4042.

After the lens 112 is thusly secured to the LED 500, the movable plate 402 is moved in a direction away from the stationary plate 401 (moved downward in the vertical direction). Consequently, the molded lens 112 is released from the lens-shaped recess 4031, and an insert-molded product comprising the integrally-molded LED 500 and lens 112 remains in the LED-shaped recess 4041.

When the movable plate 402 is moved in a direction away from the stationary plate 401, then the EJ pin 408 is moved from below upward in the vertical direction. The pin for LED 408a of the EJ pin 408 acts to push the bottom of the base support 111b for the LED 500 inserted in the LED-shaped recess 4041 from below upward in the vertical direction, and simultaneously the pin for lens 408b acts to push the bottom of the lens 112 secured to the LED 500 from below upward in the vertical direction. This makes it possible to remove the insert-molded product comprising the integrally-molded LED 500 and lens 112 from the LED-shaped recess 4041.

At the time of removal of the insert-molded product from the LED-shaped recess 4041, if the bottom of the lens 112 alone is pushed up by the EJ pin 408, separation of the LED 500 from the lens 112 may take place. Furthermore, if the bottom of the base support 111b alone is pushed up by the EJ pin 408, an unusual load may be applied when the locator boss part 501 formed at the bottom of the lens 112 is released from the resin flow-receiving recess 4042, which results in misalignment between the optical axis S of the LED chip 111a and the optical axis S1 of the lens 112. In this embodiment, to remove the insert-molded product from the LED-shaped recess 4041, the bottom of the base support 111b is pushed up by the pin for LED 408a, and simultaneously the bottom of the lens 112 is also pushed up by the pin for lens 408b fixed to the ejector plate 409a, which eliminates the occurrence of such problems as above described.

After being removed from the LED-shaped recess 4041 in that way, the insert-molded product still has the locator boss part 501 formed at the bottom of the lens 112, and thus this locator boss part 501 is cut away, whereupon the process of insert molding comes to an end.

As described heretofore, with use of the insert molding machine 400, the insert-molded product comprising the LED 500 with the lens 112 fixed thereto can be formed so long as the following conditions are fulfilled:

(1) the range of variation in the insertion of the LED 500 into the LED-shaped recess 4041 in the horizontal direction is “40 μm”; and

(2) the lens 112 is molded so that the permissible range of horizontal displacement of the optical axis S1 is “10 μm or less”.

That is, by virtue of the insert molding technique using the insert molding machine 400, the amount of optical-axis misalignment, namely the amount of misalignment between the optical axis S1 of the lens 112 and the optical axis S of the LED chip 111a can be adjusted to be less than or equal to “50 μm” which is a maximum value of the sum of “40 μm” and “10 μm or less” as above described. It is desirable to allow for a margin of 20 μm aside from the above-described permissible range of misalignment. In this case, with use of the insert molding machine 400, the permissible range of the amount of optical-axis misalignment can be set at 70 μm or less, while ensuring a sufficient level of uniformity in brightness at the liquid-crystal panel 2-sided surface of the diffusion plate 3 (unevenness in brightness falls within 8%), and this makes it possible to form an insert-molded product in which the optical axis S1 of the lens 112 and the optical axis S of the LED chip 111a substantially coincide with each other.

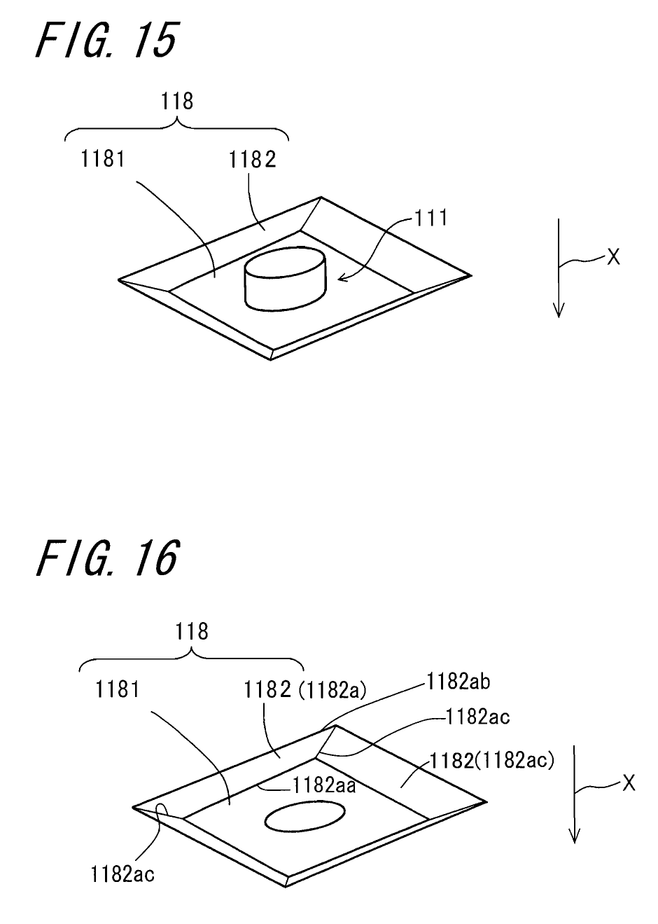

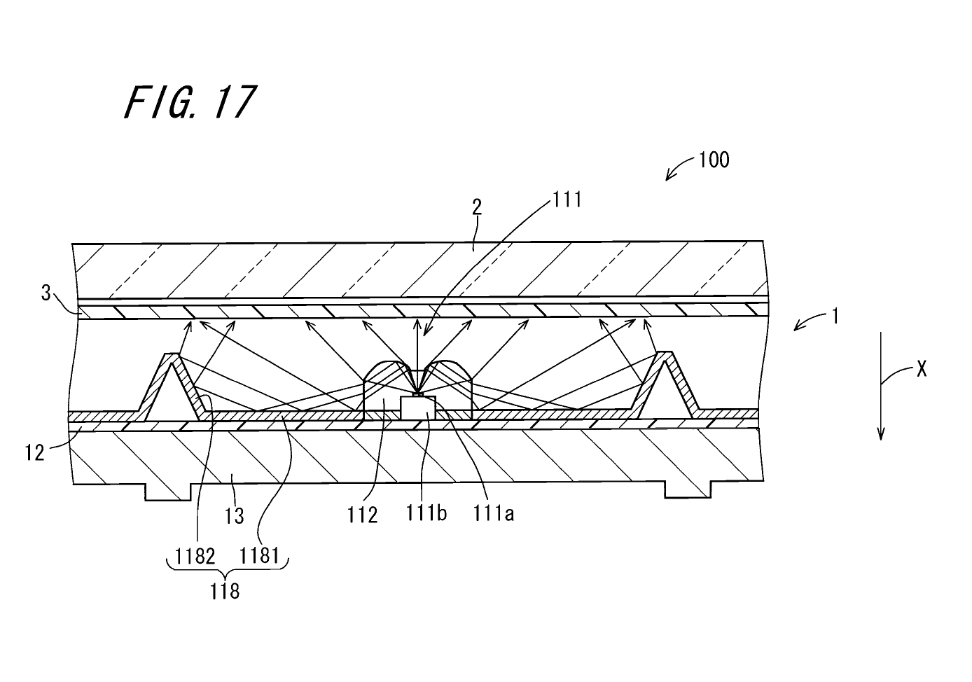

Now, the reflective member 118 will be described with reference to FIGS. 15 and 16. FIG. 15 is a perspective view of the reflective member 118 and the light-emitting portion 111, and FIG. 16 is a perspective view of the reflective member 118. In addition, FIG. 17 is a view showing the optical path of light emitted from the light-emitting portion 111.

The reflective member 118 is a member for reflecting incident light. The reflective member 118 exhibits high reflectivity, or ideally a reflectivity of 100%, for light radiating from the LED chip 111a. Note that the reflectivity of the material constituting the reflective member 118 in itself can be measured in conformity to JIS K 7375.

The reflective member 118 is made of high-luminance PET (Polyethylene Terephthalate), aluminum, or the like. The high-luminance PET is foamed PET containing a fluorescent agent, and examples thereof include E60V (product name) manufactured by TORAY Industries, Inc. The reflective member 118 has a thickness in a range of 0.1 to 0.5 mm, for example. Moreover, in the light-emitting devices 11 arranged adjacent each other, given that the length of a side of the square light-emitting device 11 is 55 mm, then the spacing between the middle points of their respective reflective members 118 falls in the range of 55 mm to 58 mm, for example.

The reflective member 118 has a polygonal outer shape, for example, a square outer shape when viewed in a plan view in the direction X. The reflective member 118 comprises the first reflecting portion 1181 which is “a base portion” according to the invention and the second reflecting portion 1182 which is “an inclined portion” according to the invention. The first reflecting portion 1181, which has a square outer shape when viewed in a plan view in the direction X, extends in a direction perpendicular to the optical axis S of the LED chip 111a on the printed circuit board 12. The second reflecting portion 1182, which surrounds the first reflecting portion 1181, is so shaped that, with increasing a distance from the LED chip 111a in a direction perpendicular to the direction X, it extends gradually toward the diffusion plate 3 away from the printed circuit board 12 while being inclined at an angle to the direction of the optical axis S of the LED chip 111a. Accordingly, the reflective member 118 composed of the first reflecting portion 1181 and the second reflecting portion 1182 has the form of an upside-down dome, the center of which is coincident with the LED chip 111a.

The first reflecting portion 1181 is so configured that each side of a square defining its shape as viewed in a plan view in the direction X becomes parallel to the direction of rows or columns of the matrix of a plurality of LED chips 111a. Moreover, the first reflecting portion 1181 is formed along the printed circuit board 12, and has a circular opening located in the middle thereof as viewed in a plan view in the direction X. The circular opening has a diameter length in a range of 10 mm to 13 mm, which is substantially equal to the diameter length L2 of the lens 112 covering the LED chip 111a, and thus, when the reflective member 118 is placed on the printed circuit board 12 after mounting the light-emitting portion 111 including the lens 112 on the printed circuit board 12, the light-emitting portion 111 is inserted into this opening.

The second reflecting portion 1182 is composed of four trapezoidal flat plates 1182a each having an isosceles-trapezoidal flat main surface. Accordingly, that surface of the second reflecting portion 1182 which faces the light-emitting portion 111 is made up of four planes.

In each of the trapezoidal flat plates 1182a, out of two opposed parallel sides of the isosceles trapezoid, the shorter one, namely a short base 1182aa merges with each side of the square first reflecting portion 1181. In each of the trapezoidal flat plates 1182a, out of two opposed parallel sides of the isosceles trapezoid, the longer one, namely a long base 1182ab lies farther away than the first reflecting portion 1181 with respect to the printed circuit board 12 in the direction X; that is, located closer to the diffusion plate 3 acting as the illumination object (or the liquid-crystal panel 2). The adjacent trapezoidal flat plates 1182a are continuous with each other at two opposed non-parallel sides of the isosceles trapezoid, namely the legs 1182ac thereof.

For example, an angle of inclination θ1 between the trapezoidal flat plate 1182a and the printed circuit board 12 falls in the range of 45° to 85°, and this inclination angle is set at 80° in this embodiment. Moreover, in this embodiment, a height H2 of the reflective member 118 falls in the range of 2.5 to 5 mm, for example. Note that the height H2 is a distance in the direction X between a part of the second reflecting portion 1182 which lies farthest from the surface of the first reflecting portion 1181 in the direction X and the surface of the first reflecting portion 1181 in the direction X.

The value of the sum of the areas of the four trapezoidal flat plates 1182a projected on the diffusion plate 3 acting as the illumination object (or the liquid-crystal panel 2) is smaller than the area of the first reflecting portion 1181 having the shape of a square with a circular opening formed in the middle thereof projected on the diffusion plate 3 acting as the illumination object (or the liquid-crystal panel 2). That is, the projected area of the first reflecting portion 1181 relative to the illumination object is greater than the projected area of the second reflecting portion 1182 relative to the illumination object.

In this embodiment, the length of a side of the square light-emitting device 11 is 55 mm, and the inclination angle θ1 is 80°. Accordingly, given that the height H2 of the reflective member 118 is 5 mm, then the area of a single trapezoidal flat plate 1182a constituting the second reflecting portion 1182 projected on the diffusion plate 3 acting as the illumination object (or the liquid-crystal panel 2) can be expressed in equation form as: {55+(55−2×5/tan θ1)}×(5/tan θ1)×½≈47.7 [mm²]. Hence it follows that the area of the second reflecting portion 1182 projected on the diffusion plate 3 acting as the illumination object (or the liquid-crystal panel 2) can be expressed in equation form as: 47.7×4=190.8 [mm²]. On the other hand, given that the diameter of the circular opening formed in the first reflecting portion 1181 is 10 mm, then the area of the first reflecting portion 1181 projected on the diffusion plate 3 acting as the illumination object (or the liquid-crystal panel 2) can be expressed in equation form as: (55−2×5/tan θ1)×(55−2×5/tan θ1)−5×5×3.14≈2755.6 [mm²]. Accordingly, the projected area of the first reflecting portion 1181 relative to the illumination object is 10 or more times greater than the projected area of the second reflecting portion 1182 relative to the illumination object.

It is preferable that the thusly constructed reflective members 118 provided in their respective light-emitting devices 11 are molded integrally with each other. As the method of integrally molding a plurality of reflective members 118, where the reflective member 118 is made of foamed PET, vacuum molding technique can be adopted, and, where the reflective member 118 is made of aluminum, press molding technique can be adopted (a process of press-molding a metal material using a mold).

For example, to achieve integral molding of a plurality of foamed PET-made reflective members 118 by the vacuum molding technique, the following steps are performed. At first, a foamed PET-made sheet is softened under application of heat, and then the sheet is fixed to the upper part of a mold with a large number of small holes for vacuum suction (vacuum holes) formed in it. Next, after the mold or the sheet is moved to hermetically seal the space between the sheet and the mold for prevention of air leakage, the internal air is rapidly released through the vacuum holes. In this internally depressurized state, the sheet is pressed against the surface of the mold under atmospheric pressure so as to faithfully reproduce the shape of the mold. The thusly molded product is removed from the mold after cooling treatment, whereupon an integrally-molded reflective member 118 can be produced.

Thus, by integrally molding the reflective members 118 provided in their respective light-emitting devices 11, it is possible to improve the accuracy of placement positions of the light-emitting portions 111 relative to their respective reflective members 118, and thereby allow the reflective member 118 to reflect light in a manner such that a higher level of uniformity in brightness is ensured in the illumination object in the planar direction. In addition, by virtue of the integral molding of the reflective members 118, it is possible to reduce the number of process steps required for installation of the reflective member 118 during assembly of the backlight unit 1, and thereby increase the efficiency of assembly operation.

According to the backlight unit 1 having the light-emitting devices 11 thusly constructed, out of light emitted from the lens 112, light emitted from the side surface 112b of the lens 112 is partly incident on the first reflecting portion 1181 of the reflective member 118, and is diffused. Since the first reflecting portion 1181 extends along the printed circuit board 12 in perpendicular relation to the optical axis S1 of the lens 12, it follows that part of the light diffused on the first reflecting portion 1181 is applied to a part of the diffusion plate 3 acting as the illumination object (or the liquid-crystal panel 2) on which is projected the first reflecting portion 1181 as viewed in a plan view in the direction X. That is, where the optical path of part of the light emitted from the side surface 112b of the lens 112 of the light-emitting portion 111 is concerned, as shown in FIG. 17, the light is incident on the first reflecting portion 1181, is reflected therefrom, and is directed toward the illumination object.

The other part of the light diffused on the first reflecting portion 1181 is incident on the second reflecting portion 1182 surrounding the outer edge of the first reflecting portion 1181. As used herein, the term “outer edge of the first reflecting portion 1181” refers to an outermost part of the first reflecting portion 1181 with respect to the optical axis S when viewed in a plan view in the direction of the optical axis S, that is, a boundary between the first reflecting portion 1181 and the second reflecting portion 1182. Since the second reflecting portion 1182 is so shaped that it extends away from the printed circuit board 12 as it runs outward (with distance from the LED chip 111a), and that its surface facing the light-emitting portion 111 is composed of a plurality of planes, it follows that light incident on the second reflecting portion 1182 is reflected therefrom toward the liquid-crystal panel 2 disposed in parallel with the printed circuit board 12, so that it can be applied to a part of the diffusion plate 3 acting as the illumination object (or the liquid-crystal panel 2) on which is projected the second reflecting portion 1182 as viewed in a plan view in the direction X. That is, where the optical path of part of the light emitted from the side surface 112b of the lens 112 of the light-emitting portion 111 is concerned, as shown in FIG. 17, the light is incident on the first reflecting portion 1181, is reflected therefrom, is incident on the second reflecting portion 1182, is reflected therefrom, and is eventually directed toward the illumination object.

As described heretofore, in this embodiment, even if the second reflecting portion 1182 is given a flat-plate shape rather than a substantially arc-like shape, that region of the diffusion plate 3 acting as the illumination object (or the liquid-crystal panel 2) on which is projected the first reflecting portion 1181 as viewed in a plan view in the direction X, as well as that region thereof on which is projected the second reflecting portion 1182 as viewed in a plan view in the direction X, can be irradiated with a sufficient quantity of light. Accordingly, the backlight unit 1 is capable of applying light to the illumination object with uniformity in brightness in the planar direction, and can be also made lower in profile. That is, according to this embodiment, by the reflecting action of the flat plate-shaped first reflecting portion 1181, light emitted from the light-emitting portion 111 is able to travel as far away from the light-emitting portion 111 as possible in the planar direction, and, in a distant place where the light reaches, reflection is caused by the flat plate-shaped second reflecting portion 1182, whereby light can be supplied to that region of the diffusion plate 3 acting as the illumination object (or the liquid-crystal panel 2) located far away from the light-emitting portion 111 where the quantity of light tends to be small. In consequence, even in the low-profile backlight unit 1, a sufficient level of uniformity in brightness can be ensured in the planar direction.

Moreover, in this embodiment, the area of the first reflecting portion 1181 projected on the illumination object is greater than the area of the second reflecting portion 1182 projected on the illumination object. The larger the projected area of the first reflecting portion 1181 is, the larger the area of irradiation of light emitted from the lens 112 on the first reflecting portion 1181 is, wherefore the quantity of light applied to the illumination object by the reflecting action of the first reflecting portion 1181 is increased, and the quantity of light applied to the second reflecting portion 1182 by the reflecting action of the first reflecting portion 1181 is also increased, and consequently, the quantity of light around the reflective member 118 can be increased for attainment of a higher level of uniformity in brightness in the planar direction of the illumination object.

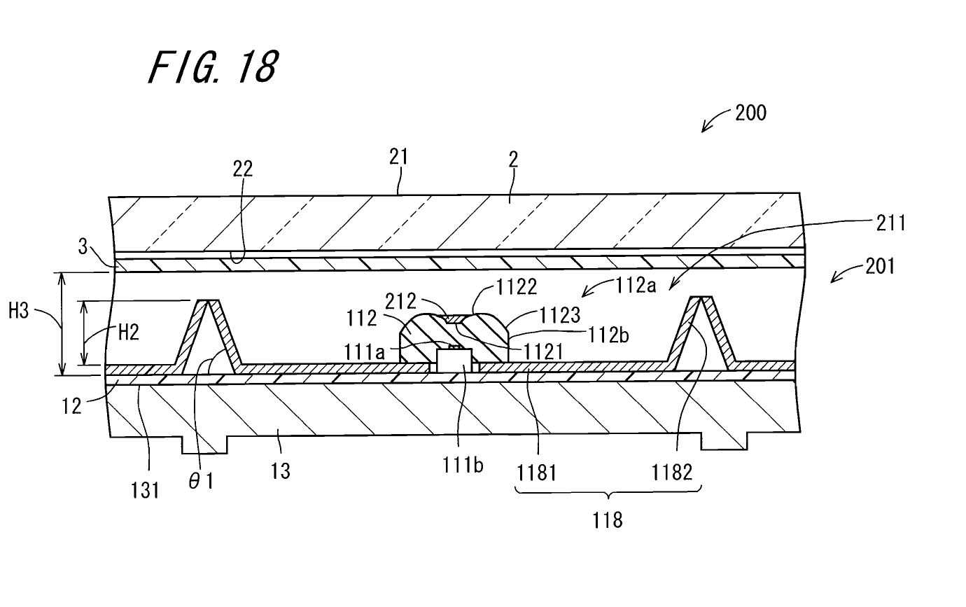

FIG. 18 is a sectional view showing the structure of a liquid-crystal display apparatus 200 in accordance with a second embodiment of the invention. The liquid-crystal display apparatus 200 is analogous to the liquid-crystal display apparatus 100 of the preceding first embodiment, and therefore the components that play the same or corresponding roles as in the first embodiment will be identified with the same reference symbols, and overlapping descriptions will be omitted.

In the liquid-crystal display apparatus 200, except that a light-emitting device 211 of a backlight unit 201 differs structurally from the light-emitting device 11 of the backlight unit 1 described earlier, the liquid-crystal display apparatus 200 is similar to the liquid-crystal display apparatus 100.

In the light-emitting device 211 of the backlight unit 201, at the bottom of the recess portion 1121 located centrally of the lens 112 is formed a light quantity attenuation portion 212 for diminishing the quantity of incident light. The light quantity attenuation portion 212 diminishes the quantity of light emitted from the lens 112 by causing a scattering of light emitted from the recess portion 1121 of the lens 112, by lessening transmitted light, or by causing reflection. In this embodiment, the center of the light quantity attenuation portion 212, as well as the center of the recess portion 1121, is located on the optical axis S of the LED chip 111a. The light-attenuating structure of the light quantity attenuation portion 212 can be implemented by blast treatment, pattern emplacement during molding, adhesion of fine particles such as silica, magnesium oxide, or white pigments, or formation of a reflecting material made of aluminum or the like by means of vapor deposition, coating, bonding, or otherwise.

In the backlight unit 201 of this embodiment, since the light quantity attenuation portion 212 for diminishing the quantity of incident light is formed in the middle of the recess portion 1121 located directly above the LED chip 111a, it is possible to achieve reduction in the quantity of light emitted from the recess portion 1121 specifically for a region directly above the LED chip 111a where a large quantity of light reaches.

Accordingly, the backlight unit 201 of this embodiment, in the form of a direct-lighting type backlight device using the LED chip 111a for light emission as a light source, is capable of applying light to the liquid-crystal panel 2 with uniformity in brightness in the planar direction by each light-emitting device 211. This makes it possible to prevent localized brightness variations in the planar direction of the liquid-crystal panel 2 in the liquid-crystal display apparatus 200, and thereby allow the liquid-crystal display apparatus 200 to display high-quality images with little unevenness in brightness.

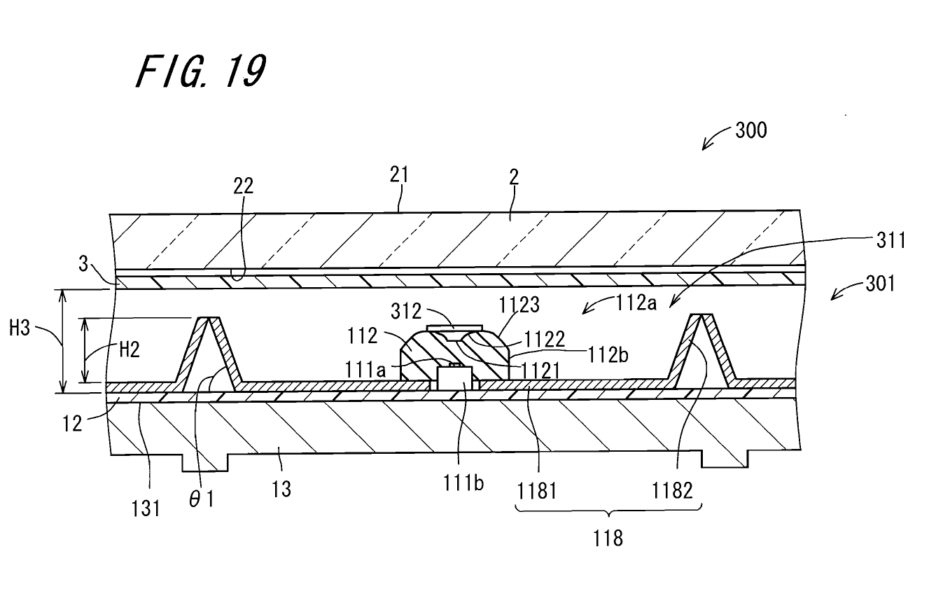

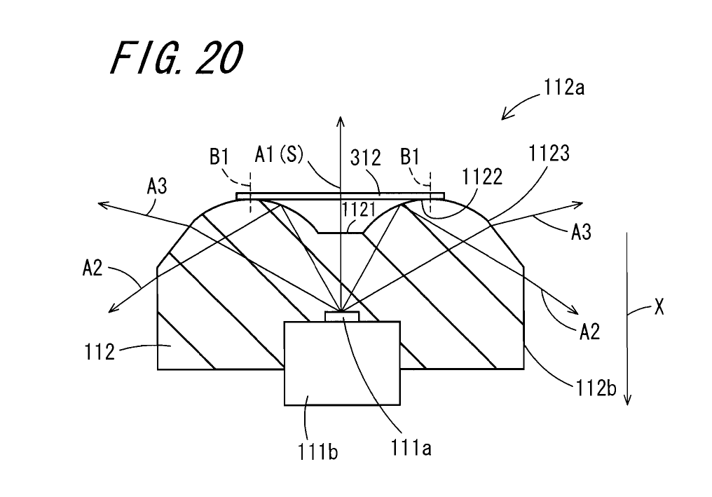

FIG. 19 is a sectional view showing the structure of a liquid-crystal display apparatus 300 in accordance with a third embodiment of the invention. FIG. 20 is an enlarged view showing a main part of the liquid-crystal display apparatus 300. The liquid-crystal display apparatus 300 is analogous to the liquid-crystal display apparatus 100 of the preceding first embodiment, and therefore the components that play the same or corresponding roles as in the first embodiment will be identified with the same reference symbols, and overlapping descriptions will be omitted.

In the liquid-crystal display apparatus 300, except that a light-emitting device 311 of a backlight unit 301 differs structurally from the light-emitting device 11 of the backlight unit 1 described earlier, the liquid-crystal display apparatus 300 is similar to the liquid-crystal display apparatus 100.

In the light-emitting device 311 of the backlight unit 301, in a region between the lens 112 and the liquid-crystal panel 2, a light quantity adjustment member 312 is attached to the top surface 112a of the lens 112 in parallel with the printed circuit board 12. The light quantity adjustment member 312 is a member having the shape of a circular plate made, for example, of acrylic resin.

The light quantity adjustment member 312 is intended to adjust light coming from the lens 112. The light quantity adjustment member 312 is so designed that its upper surface facing the liquid-crystal panel 2 acts as a diffusion surface for diffusing light, and that part of its lower surface facing the lens 112 which is opposed at least to the recess portion 1121 reflects light.

In the backlight unit 301 provided with such a light quantity adjustment member 312, high-intensity light emitted from the recess portion 1121 of the lens 112 is reflected from the reflecting region formed on the lower surface of the light quantity adjustment member 312 so as to enter the lens 112 once again, and is then diffused in the interior of the lens 112. Moreover, light which entered the light quantity adjustment member 312 and then reached the upper surface thereof (diffusion surface) is diffused by this surface so as to be directed toward the liquid-crystal panel 2.

The light quantity adjustment member 312 attenuates high-intensity light by reflection, and also diffuses partly-transmitted light. As shown in FIG. 20, it is preferable that the light quantity adjustment member 312 having such functions is so formed as to extend up to a position beyond a boundary B1 between the first curved portion 1122 and the second curved portion 1123 of the lens 112 in a direction toward the second curved portion 1123. This makes it possible to apply the light diffused by the light quantity adjustment member 312 to the illumination object opposed to the first curved portion 1122, and thereby make up for the insufficiency of light resulting from light reflection by the first curved portion 1122.

Moreover, in the boundary B1 between the first curved portion 1122 and the second curved portion 1123 of the lens 112, there may be a case where a phenomenon occurs in which the illumination object corresponding to the boundary B1 is irradiated with a ring-like ray of light which is higher in brightness than light on both sides of the boundary B1. In this regard, by forming the light quantity adjustment member 312 so as to extend up to a position beyond the boundary B1 between the first curved portion 1122 and the second curved portion 1123 in a direction toward the second curved portion 1123, it is possible to suppress occurrence of the phenomenon in which the illumination object corresponding to the boundary B1 is irradiated with a ring-like ray of light which is higher in brightness than light on both sides (of the boundary B1). Note that, rather than being formed so as to cover the entire region of the second curved portion 1123, the light quantity adjustment member 312 is advisably so designed that the length of the part of the light quantity adjustment member 312 extending from the boundary B1 toward the second curved portion 1123 is such as to suppress occurrence of the phenomenon in which the illumination object is irradiated with the above-described ring-like ray of light exhibiting high brightness.

The light quantity adjustment member 312 formed so as to extend up to a position beyond the boundary B1 between the first curved portion 1122 and the second curved portion 1123 in a direction toward the second curved portion 1123 can be fixed to an area close to the boundary B1 by using, for example, a double-faced tape. In the case of fixing the light quantity adjustment member 312 by a double-faced tape, since the double-faced tape in itself may become a diffusely-reflecting surface, it is desirable to place the double-faced tape so that it will not cover the second curved portion 1123.

As has already been described, the role of the light quantity adjustment member 312 is not only to attenuate high-intensity light by reflection, but also to make up for the insufficiency of light at a part of the diffusion plate 3 which corresponds to the first curved portion 1122 defined as the first region, and thus, the light quantity adjustment member 312 allows light to pass therethrough to the extent that the part of the diffusion plate 3 corresponding to the first curved portion 1122 will not be brought into a low-light condition, with subsequent diffusion being effected. The rest of the light is reflected therefrom for reuse of light.

Accordingly, the backlight unit 301 of this embodiment is capable of applying light to the liquid-crystal panel 2 with uniformity in light intensity in the planar direction.

In the backlight unit 301, as is the case with the earlier described backlight unit 201, it is advisable to provide the light quantity attenuation portion 212 at the bottom of the recess portion 1121 of the lens 112. In this case, the light quantity adjustment member 312 receives light which has been attenuated in quantity by the light quantity attenuation portion 212. Accordingly, the liquid-crystal panel 2 can be efficiently irradiated with light with uniformity in brightness in the planar direction.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1, 201, 301: Backlight unit
2: Liquid-crystal panel
3: Diffusion plate
11, 211, 311: Light-emitting device
12: Printed circuit board
13: Frame member
100, 200, 300: Liquid-crystal display apparatus
111a: LED chip
111b: Base support
112: Lens
118: Reflective member
400: Insert molding machine

1. A light-emitting device for applying light to an illumination object, comprising:
a light-emitting element that emits light;
a base support that supports the light-emitting element; and
a columnar optical member disposed on a light-emitting surface side of the light-emitting element, reflecting or refracting light emitted from the light-emitting element in a plurality of directions, the columnar optical member having a top surface which faces the illumination object and is shaped so as to have a recess at a center thereof,
the top surface of the columnar optical member including a first region which reflects light emitted from the light-emitting element and travels in an interior of the columnar optical member so that the light exits from a side surface of the columnar optical member to outside of the columnar optical member, and a second region which refracts light emitted from the light-emitting element and travels in the interior of the columnar optical member so that the light exits from the top surface.

2. The light-emitting device according to claim 1,
wherein the first region lies closer to the light-emitting element than the second region.

3. The light-emitting device according to claim 1, further comprising:
a light quantity attenuation portion disposed in the recess at the center of the top surface of the columnar optical member, the light quantity attenuation portion diminishing a quantity of incident light.

4. The light-emitting device according to claim 1, further comprising:
a light quantity adjustment member disposed on an optical axis of the light-emitting element in a region between the columnar optical member and the illumination object to be fixed to the top surface of the columnar optical member, the light quantity adjustment member adjusting light from the columnar optical member.

5. The light-emitting device according to claim 4,
wherein the light quantity adjustment member is configured so as to extend up to a position beyond a boundary between the first region and the second region of the top surface of the columnar optical member in a direction toward the second region.

6. The light-emitting device according to claim 1,
wherein the columnar optical member has a reflection portion for reflecting light at a bottom thereof.

7. The light-emitting device according to claim 1, further comprising:
a reflective member that reflects light emitted from the columnar optical member, the reflective member comprising a base portion disposed around the columnar optical member so as to extend in a flat form in a direction perpendicular to an optical axis of the columnar optical member, and
an inclined portion surrounding the columnar optical member to be inclined with respect to the base portion, a surface of the inclined portion facing the columnar optical member extending in a flat form.

8. An illuminating apparatus comprising:
a plurality of the light-emitting devices according to claim 7, the plurality of the light-emitting devices being arranged in an orderly manner.

9. The illuminating apparatus according to claim 8,
wherein a plurality of the reflective members provided in the light-emitting devices are integrally formed at inclined portions thereof so that the reflective members are continuous with respective adjacent ones.

10. A display apparatus comprising:
a display panel; and
an illuminating apparatus including the light-emitting device according to claim 1, the illuminating apparatus applying light to a back side of the display panel.

11. A display apparatus comprising:
a display panel; and
the illuminating apparatus according to claim 8, the illuminating apparatus applying light to a back side of the display panel.
